(19) United States
(12) Patent Application Publication
(10) Pub. No.: US 2004/0091243 A1
(43) Pub. Date: May 13, 2004

(54) Image processing

(76) Inventors: Eric Yves Theriault, Montreal (CA); Le Huan Tran, Pointe-Claire (CA)

Correspondence Address: GATES & COOPER LLP, HOWARD HUGHES CENTER, 6701 CENTER DRIVE WEST, SUITE 1050, LOS ANGELES, CA, 90045, US

(21) Appl. No.: 10/403,874

(22) Filed: Mar. 31, 2003

(30) Foreign Application Priority Data
Nov. 12, 2002 (GB) 02 26 295.4

(51) Int. Cl. H04N 5/93; G11B 27/00

(52) U.S. Cl. 386/52; 386/64

(57) ABSTRACT

Image editing apparatus, comprising a plurality of image processing systems and a plurality of frame storage means. Some or all of the image processing systems are connected to a high bandwidth switching means, as are some or all of the frame storage means. The switching means forms a connection between a first image processing system and a first frame storage means, and the first image processing system accesses data stored on an additional processing system that is necessary to access frames stored as clips on the first frame storage means. This data comprises information specifying, for each frame on the first frame storage means, the clip to which it belongs, its position in that clip and effects to be applied to the frame.

### CROSS-REFERENCE TO RELATED APPLICATIONS

This application claims the benefit under 35 U.S.C. § 119 of the following co-pending and commonly-assigned patent application, which is incorporated by reference herein:

United Kingdom Patent Application Number 02 26 295.4, filed on Nov. 12, 2002, by Eric Yves Theriault and Le Huan Tran, entitled “IMAGE PROCESSING”.

This application is related to the following commonly-assigned United States patent and pending patent application, which are incorporated by reference herein:

U.S. Pat. No. 6,118,931, filed on Apr. 11, 1997 and issued on Sep. 12, 2000, by Raju C. Bopardikar, entitled “VIDEO DATA STORAGE”, Attorney's Docket Number 30566.207-US-U1; and

U.S. patent application Ser. No. 10/124,093, filed on Apr. 17, 2002, by Eric Yves Theriault and Le Huan Tran, entitled “DATA STORAGE WITH STORED LOCATION DATA TO FACILITATE DISK SWAPPING”.

### BACKGROUND OF THE INVENTION

1. Field of the Invention

The present invention relates to storage of data within an image processing environment.

2. Description of the Related Art

Devices for the real time storage of image frames, derived from video signals or derived from the scanning of cinematographic film, are disclosed in the present applicant's U.S. Pat. No. 6,118,931. In the aforesaid patent, systems are shown in which image frames are stored at display rate by accessing a plurality of storage devices in parallel under a process known as striping.

Recently, there has been a trend towards networking a plurality of systems of this type. An advantage of connecting systems of this type in the network is that relatively low powered machines may be deployed for relatively simple tasks, such as the transfer of image frames from external media, thereby allowing the more sophisticated equipment to be used for the more processor-intensive tasks such as editing and compositing etc. However, a problem then exists in that data may have been captured to a first frame storage system having a direct connection to a first processing system but, for subsequent manipulation, access to the stored data is required by a second processing system.

In the present applicant's U.S. patent application Ser. No. 10/124,093 this problem is solved by swapping framestores between processing systems. However data known as metadata, which must be accessed in order to make sense of the image data stored on the framestores, must also be swapped over a network. This metadata represents the entire creative input of the users of the editing systems, and constant movement of it in this way can lead to its corruption and even loss. There is therefore a need for a more robust way of storing and accessing the metadata.

### BRIEF OF THE INVENTION

According to a first aspect of the invention, there is provided image editing apparatus, comprising a high bandwidth switching means, a plurality of image processing systems, at least one of which is connected to said high bandwidth switching means, an additional processing system connected to said plurality of processing systems, and a plurality of frame storage means, at least one of which is connected to said high bandwidth switching means. Said high bandwidth switching means is configured to make a connection between a first image processing system and a first frame storage means, wherein said first image processing system and said first frame storage system are both connected to said high bandwidth switching means, and said first image processing system reads data stored on said additional processing system that is necessary to access frames stored on said first frame storage means.

According to a second aspect of the invention, there is provided, within an image processing environment, a method of processing image data. The environment comprises a high bandwidth switching means, a plurality of image processing systems, at least one of which is connected to said high bandwidth switching means, an additional processing system connected to said plurality of processing systems, and a plurality of frame storage means, at least one of which is connected to said high bandwidth switching means. The method comprises the steps of connecting, via said high bandwidth switching means, a first image processing system to a first frame storage means, wherein said first image processing system and said first frame storage means are both connected to said high bandwidth switching means; reading, at said first image processing system, data stored on said additional processing system; and using, at said first image processing system, said data to access frames stored on said first frame storage means.

### BRIEF DESCRIPTION OF THE DRAWINGS

The invention will be described below by way of a preferred embodiment illustrated in the drawings, in which:

FIG. 1 shows an image processing environment;

FIG. 2 illustrates an on-line editing system as shown in FIG. 1;

FIG. 3 details a processor forming part of the on-line editing system as illustrated in FIG. 2;

FIG. 4 illustrates an off-line editing system as shown in FIG. 1;

FIG. 5 details a processor forming part of the off-line editing system as illustrated in FIG. 4;

FIG. 6 illustrates a network storage system as shown in FIG. 1;

FIG. 7 illustrates a number of image frames;

FIG. 8 illustrates a method of striping the image frames shown in FIG. 7 onto a framestore shown in FIG. 1;

FIG. 9 details steps carried out by the off-line editing system illustrated in FIG. 4 to capture and archive image data;

FIG. 10 details steps carried out by the on-line editing system illustrated in FIG. 2 to edit image data;

FIG. 11 illustrates a hierarchical structure for storing metadata;

FIG. 12 illustrates an example of metadata belonging to the structure shown in FIG. 11;

FIG. 13 shows the contents of the memory of the on-line editing system illustrated in FIG. 2;

FIG. 14 shows three versions of a configuration file in the memory of the on-line editing system illustrated in FIG. 2;

FIG. 15 shows a second configuration file in the memory of the on-line editing system illustrated in FIG. 2;

FIG. 16 shows a third configuration file in the memory of the on-line editing system illustrated in FIG. 2;

FIG. 17 details steps carried out to execute an application on the on-line editing system illustrated in FIG. 2;

FIG. 18 details steps carried out in FIG. 17 to initialise the application;

FIG. 19 details steps carried out in FIG. 18 to initialise framestore access;

FIG. 20 details steps carried out in FIG. 18 to initialise the display of the application;

FIG. 21 details steps carried out in FIG. 18 to initialise a user interface;

FIG. 22 illustrates the application with an initialised user interface as displayed on the on-line editing system illustrated in FIG. 2;

FIG. 23 details steps carried out in FIG. 17 to create the user interface;

FIG. 24 details steps carried out in FIG. 23 to create a desktop in the user interface;

FIG. 25 details steps carried out in FIG. 23 to create a reel in the user interface;

FIG. 26 illustrates the user interface created by steps carried out in FIG. 23;

FIG. 27 shows functions carried out in FIG. 17 during the editing of image data;

FIG. 28 details a function carried out in FIG. 27 to display a clip of frames;

FIG. 29 details a function carried out in FIG. 27 to access remote frames;

FIG. 30 details steps carried out in FIG. 29 to select a framestore and project to access remotely;

FIG. 31 details steps carried out in FIG. 29 to select frames to access remotely;

FIG. 32 details steps carried out in FIG. 31 to load remote frames;

FIG. 33 details a daemon in the memory of the on-line editing system illustrated in FIG. 2 which initiates and controls a swap of framestores;

FIG. 34 illustrates an interface presented to the user of the on-line editing system illustrated in FIG. 2 by the daemon shown in FIG. 33;

FIG. 35 details steps carried out in FIG. 33 to control a swap of framestores;

FIG. 36 illustrates the contents of the memory of a patch panel controlling system shown in FIG. 1;

FIG. 37 shows a port connections table in the memory of the patch panel controlling system shown in FIG. 1;

FIG. 38 details steps carried out by the patch panel controlling system shown in FIG. 1 to control the patch panel shown in FIG. 1;

FIG. 39 details steps carried out in FIG. 38 to swap framestores;

FIG. 40 illustrates the port connections table after a swap of framestores has been carried out;

FIG. 41A illustrates connections within the patch panel shown in FIG. 1; and

FIG. 41B illustrates connections within a patch panel in another embodiment.

### WRITTEN DESCRIPTION OF THE BEST MODE FOR CARRYING OUT THE INVENTION

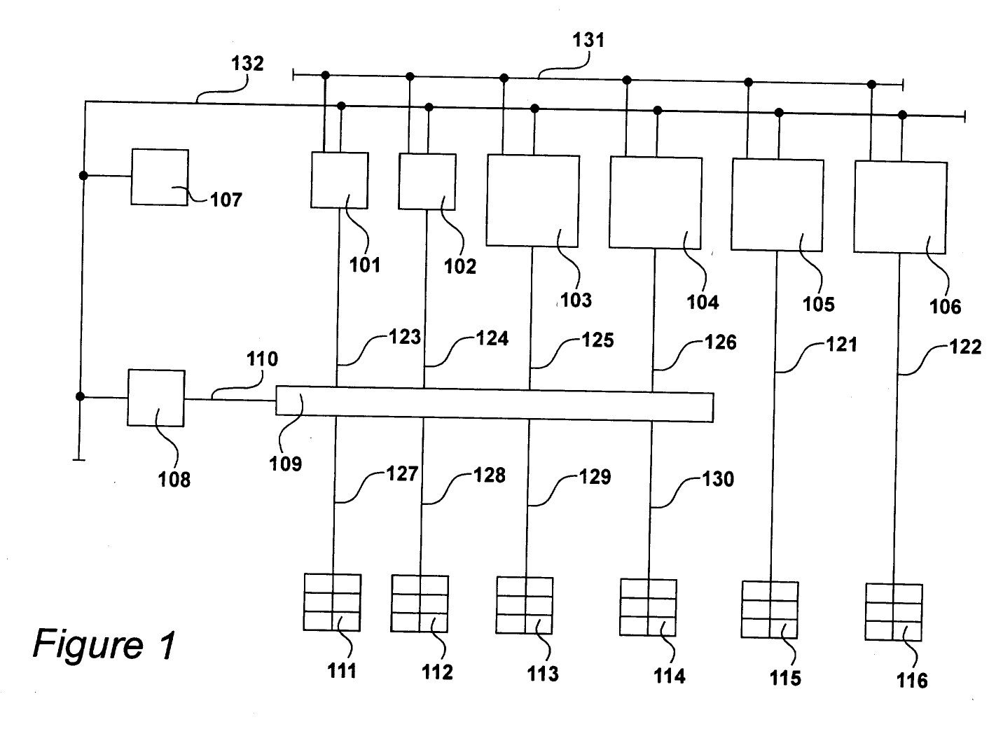

FIG. 1

FIG. 1 illustrates an image processing environment comprising a plurality of image processing systems and a plurality of frame storage means. In this example it comprises six image processing systems 101, 102, 103, 104, 105 and 106, where in this example image processing systems 101 and 102 are off-line editing systems and image processing systems 103 to 106 are on-line editing systems. These are connected by a medium bandwidth HiPPI network 131 and by a low-bandwidth Ethernet network 132 using the TCP/IP protocol. In this example the plurality of frame storage means is six framestores 111, 112, 113, 114, 115 and 116. For example, each framestore 111 to 116 may be of the type obtainable from the present applicant under the trademark ‘STONE’. Each framestore consists of two redundant arrays of inexpensive disks (RAIDs) daisy-chained together, each RAID comprising sixteen thirty-six gigabyte disks. On-line editing system 105 is connected to framestore 115 by high bandwidth connection 121. On-line editing system 106 is connected to framestore 116 by high bandwidth connection 122.

The environment further comprises a high bandwidth switching means, which in this example is patch panel 109. Editing systems 101 to 104 are connected to patch panel 109 by high bandwidth connections 123, 124, 125 and 126 respectively. Framestores 111 to 114 are connected to patch panel 109 by high bandwidth connections 127, 128, 129 and 130 respectively. Each high bandwidth connection is a fibre channel which may be made of fibre optic or copper cabling.

The environment further comprises an additional processing system 107 known as a network storage system, and a further additional processing system 108 known as a patch panel controlling system. Patch panel controlling system 108 is connected to patch panel 109 by low bandwidth connection 110 using the TCP/IP protocol. Network storage system 107 and patch panel controller 108 are also connected to Ethernet network 132.

In such an environment each of the framestores is operated under the direct control of an editing system. Thus, framestore 115 is operated under the direct control of on-line editing system 105 and framestore 116 is operated under the direct control of on-line editing system 106. Each of framestores 111 to 114 may be controlled by any of editing systems 101 to 104, with the proviso that at any time only one system can be connected to a framestore. Commands issued by patch panel controlling system 108 to patch panel 109 define physical connections within the panel between processing systems 101 to 104 and framestores 111 to 114. The patch panel 109 is therefore employed within the data processing environment to allow fast full bandwidth accessibility between each editing system 101 to 104 and each framestore 111 to 114 while also allowing flexibility of data storage.

In such an environment on-line editing systems and their operators are more expensive than off-line editing systems. Therefore it is most efficient to use each for the purpose for which it was designed. An off-line editing system can capture frames for the use of an on-line system but only if the data or, more advantageously, the framestore can be moved between the editing systems. The patch panel allows this to happen.

For example, while on-line editing system 103 is performing a task, off-line editing system 101 can be capturing frames for editing system 103's next task. When on-line editing system 103 completes the current task it swaps framestores with off-line editing system 101 and have immediate access to the frames necessary for its next task. Off-line editing system 101 now archives the results of the task which processing system 103 has just completed. This ensures that the largest and fastest editing systems are always used in the most efficient way.

On first start-up, the patch panel 109 is placed in the default condition to the effect that each of editing systems 101 to 104 is connected through patch panel 109 to framestores 111 to 114 respectively. For much of this description it will be assumed that the environment is currently in that state. At any one time the framestore to which an editing system is connected is known as its local framestore. Any other framestore is remote to that editing system and frames stored on a remote system are known as remote frames. However, when a framestore swap takes place a remote framestore becomes local and vice versa.

In addition to swapping framestores, an editing system may obtain frames stored on a remote framestore by requesting them from the editing system that controls it. These requests are sent over the fastest network supported by both systems, which in this example is the HiPPI network 131, and if the requests are granted the frames are returned in the same way. This is known as a wire transfer.

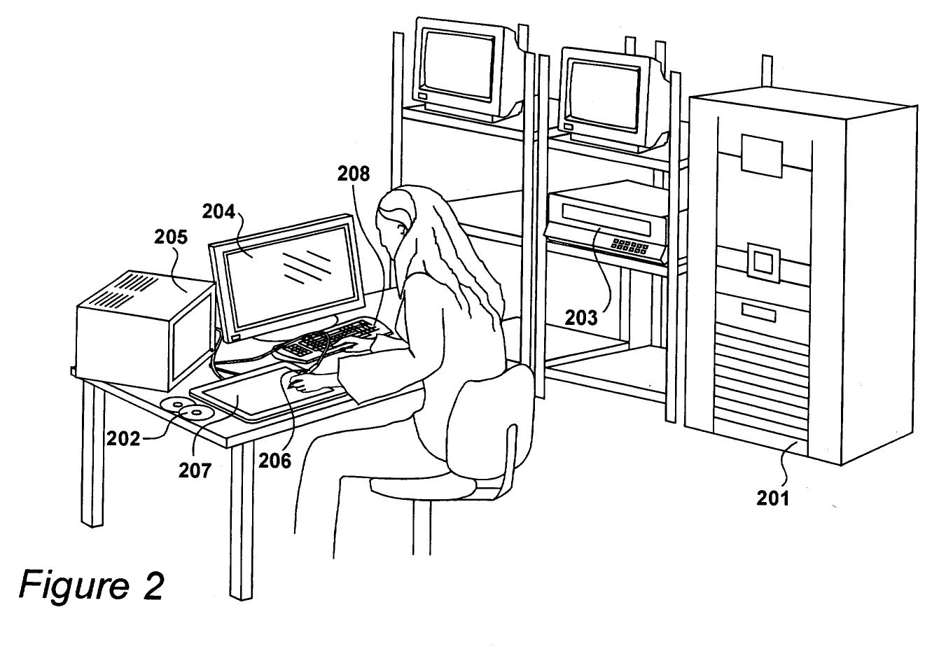

FIG. 2

An on-line editing system, such as editing system 103, is illustrated in FIG. 2, based around an Onyx™ 2 computer 201. Program instructions executable within the Onyx™ 2 computer 201 may be supplied to said computer via a data carrying medium, such as a CD ROM 202.

Frames may be captured and archived locally via a local digital video tape recorder 203 but preferably the transferring of data of this type is performed off-line, using stations 101 or 102.

An on-line editor is provided with a visual display unit 204 and a high quality broadcast quality monitor 205. Input commands are generated via a stylus 206 applied to a touch table 207 and may also be generated via a keyboard 208.

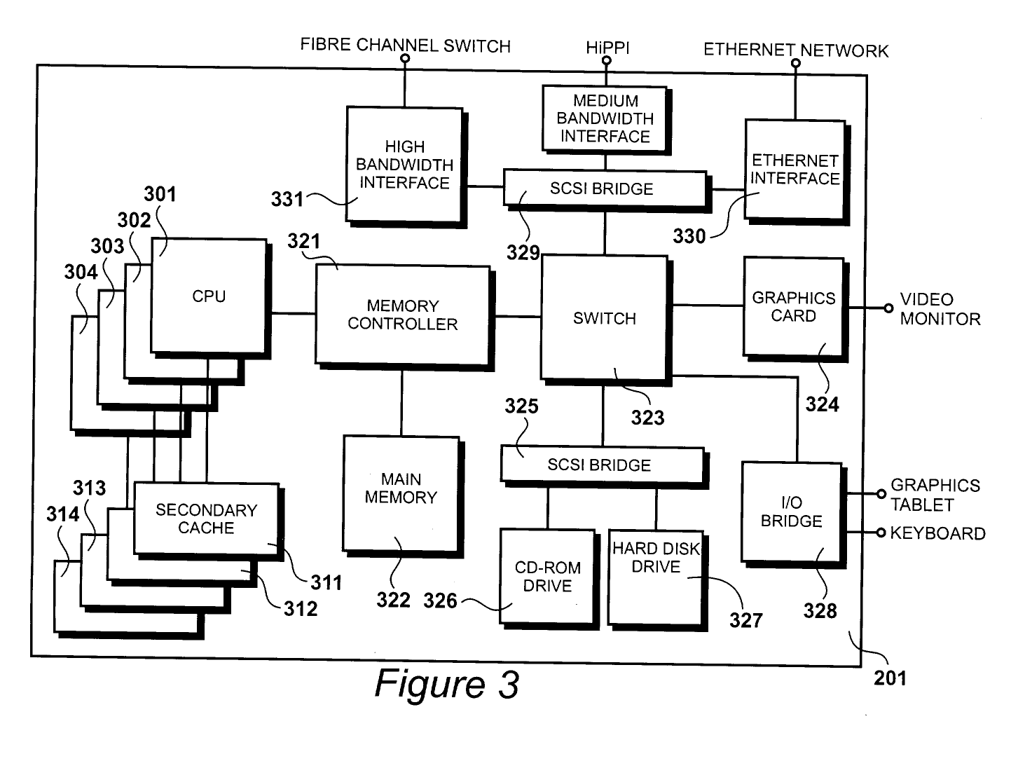

FIG. 3

The computer 201 shown in FIG. 2 is detailed in FIG. 3. Computer 201 comprises four central processing units 301, 302, 303 and 304 operating in parallel. Each of these processors 301 to 304 has a dedicated secondary cache memory 311, 312, 313 and 314 that facilitate per-CPU storage of frequently used instructions and data. Each CPU 301 to 304 further includes separate primary instruction and data cache memory circuits on the same chip, thereby facilitating a further level of processing improvement. A memory controller 321 provides a common connection between the processors 301 to 304 and a main memory 322. The main memory 322 comprises two gigabytes of dynamic RAM.

The memory controller 321 further facilitates connectivity between the aforementioned components of the computer 201 and a high bandwidth non-blocking crossbar switch 323. The switch makes it possible to provide a direct high capacity connection between any of several attached circuits, including a graphics card 324. The graphics card 324 generally receives instructions from the processors 301 to 304 to perform various types of graphical image rendering processes, resulting in frames, clips and scenes being rendered in real time.

A SCSI bridge 325 facilitates connection between the crossbar switch 323 and a DVD/CDROM drive 326. The DVD drive provides a convenient way of receiving large quantities of instructions and data, and is typically used to install instructions for the processing system 201 onto a hard disk drive 327. Once installed, instructions located on the hard disk drive 327 may be transferred into main memory 806 and then executed by the processors 301 to 304. An input output (I/O) bridge 328 provides an interface for the graphics tablet 207 and the keyboard 208, through which the user is able to provide instructions to the computer 201.

A second SCSI bridge 329 facilitates connection between the crossbar switch 323 and network communication interfaces. Ethernet interface 330 is connected to the Ethernet network 132, medium bandwidth interface 331 is connected to HiPPI network 131 and high bandwidth interface 332 is connected to the patch panel 109 by connection 125.

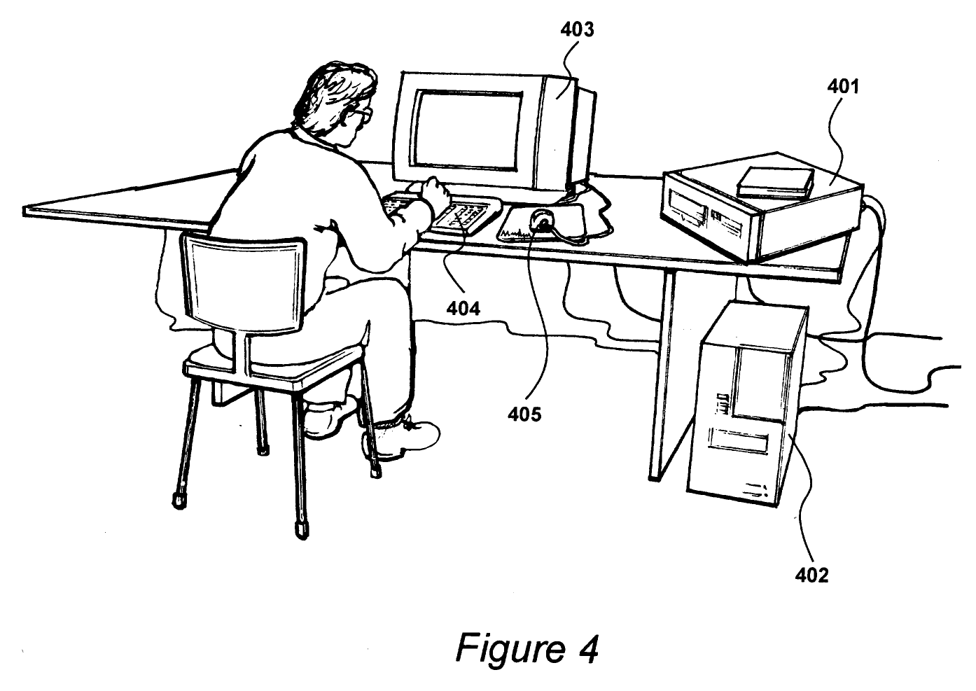

FIG. 4

An off-line editing system, such as editing system 101, is detailed in FIG. 4. New input material is captured via a high definition video recorder 401. Operation of recorder 401 is controlled by a computer system 402, possibly based around a personal computer (PC) platform. In addition to facilitating the capturing of high definition frames to framestores, processor 402 may also be configured to generate proxy images, allowing video clips to be displayed via a monitor 403. Off-line editing manipulations may be performed using these proxy images, along with other basic editing operations. An off-line editor controls operations via manual input devices including a keyboard 404 and mouse 405.

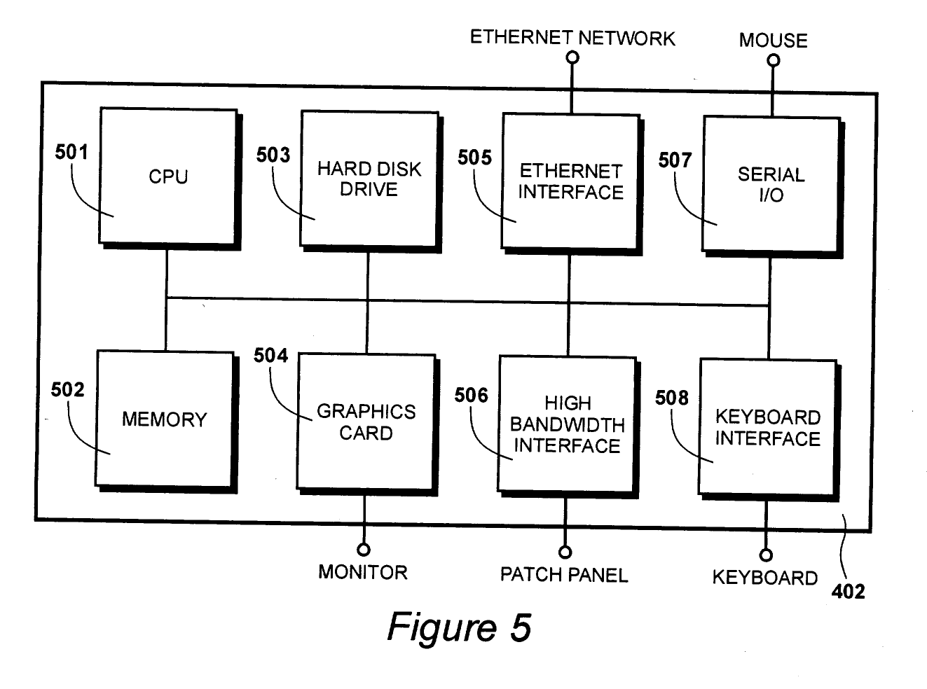

FIG. 5

Computer 402 as shown in FIG. 4 is detailed in FIG. 5. Computer 402 comprises a central processing unit (CPU) 501. This is connected via data and address connections to memory 502. A hard disk drive 503 provides non-volatile high capacity storage for programs and data. A graphics card 504 receives commands from the CPU 501 resulting in the update and refresh of images displayed on the monitor 405. Ethernet interface 505 enables network communication over Ethernet network 132. A high bandwidth interface 506 allows communication via patch panel 121. A keyboard interface 508 provides connectivity to the keyboard 404, and a serial I/O circuit 507 receives data from the mouse 405.

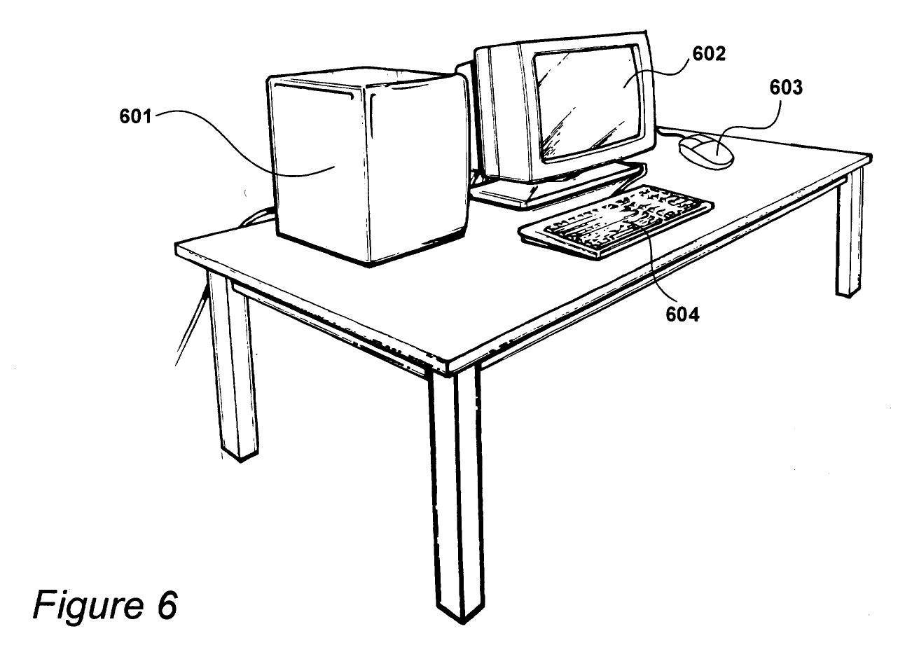

FIG. 6

Network storage system 107 is shown in FIG. 6. It comprises a computer system 601, again possibly based around a personal computer (PC) platform. Computer 601 is substantially similar to computer 402 detailed in FIG. 5. A monitor 602 is provided. When necessary, a network administrator can operate the system using keyboard 604 and mouse 605. However in general use the system has no user. It stores information relating to framestores 111 to 115 that is necessary in order to read the frames stored thereon, and this information is accessed by image processing systems 101 to 106 via Ethernet 132. Similar information relating to framestore 116 is in this example stored on the hard drive of editing system 106.

Panel controlling system 108 is substantially similar to network storage system 107. Again it has no user, although it includes input and display means for use by a network administrator when necessary. It controls patch panel 109, usually in response to instructions received from image processing systems 101 to 106 via Ethernet 132 but also in response to instructions received via a mouse or keyboard.

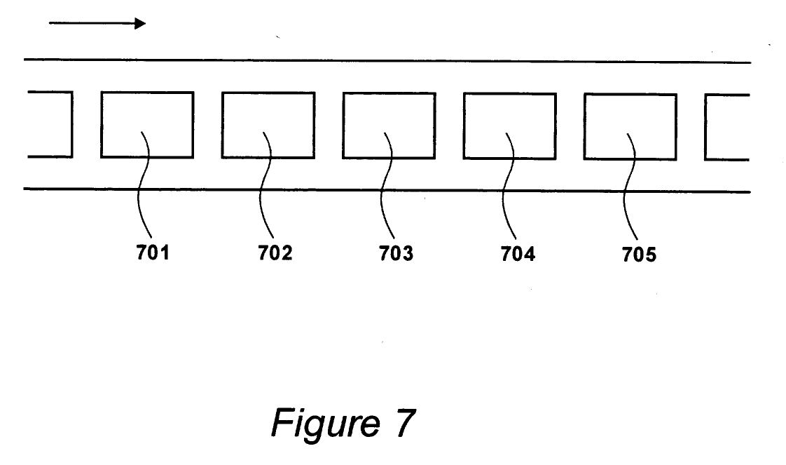

FIG. 7

A plurality of video image frames 701, 702, 703, 704 and 705 are illustrated in FIG. 7. Each frame in the clip has a unique frame identification (frame ID) such that, in a system containing many clips, each frame may be uniquely identified. In a system operating with standard broadcast quality images, each frame consumes approximately one megabyte of data. Thus, by conventional data processing standards, frames are relatively large and therefore even on a relatively large disk array the total number of frames that may be stored is ultimately limited. An advantage of this situation, however, is that it is not necessary to establish a sophisticated directory system thereby assisting in terms of frame identification and access.

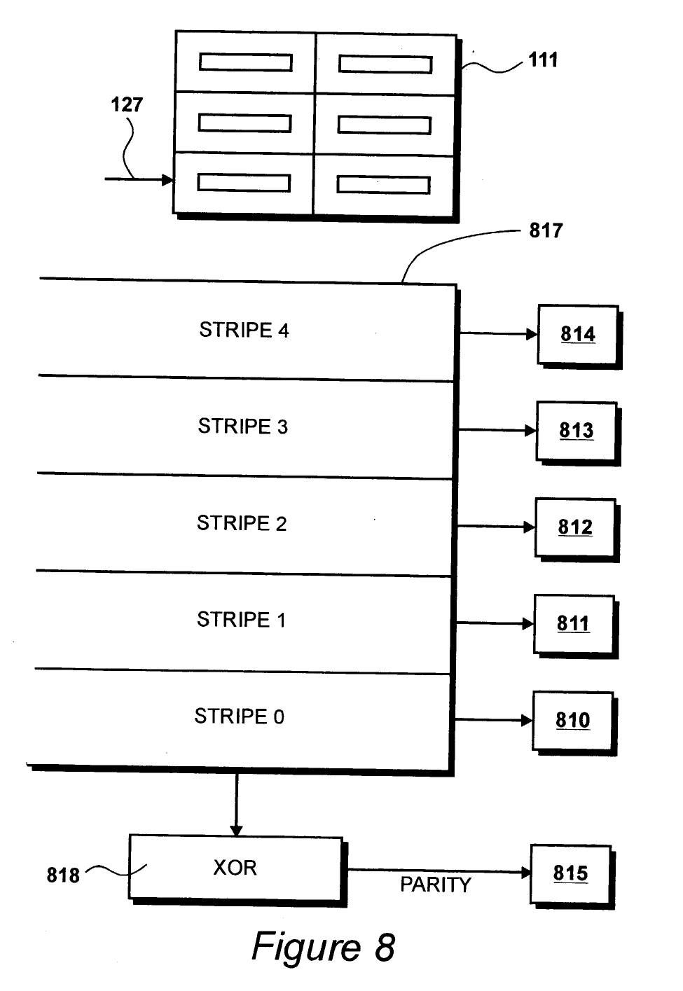

FIG. 8

A framestore, such as framestore 111, is illustrated in FIG. 8. Framestore 111, connected to patch panel 109 by fibre channel 127, includes thirty-two physical hard disk drives. Five of these are illustrated diagrammatically as drives 810, 811, 812, 813 and 814. In addition to these five disks configured to receive image data, a sixth redundant disk 815 is provided.

An image field 817, stored in a buffer within memory, is divided into five stripes identified as stripe zero, stripe one, stripe two, stripe three and stripe four. The addressing of data from these stripes occurs using similar address values with multiples of an off-set value applied to each individual stripe. Thus, while data is being read from stripe zero, similar address values read data from stripe one but with a unity off-set. Similarly, the same address values are used to read data from stripe two with a two unit off-set, with stripe three having a three unit off-set and stripe four having a four unit off-set. In a system having many storage devices of this type and with data being transferred between storage devices, a similar striping off-set is used on each system.

As similar data locations are being addressed within each stripe, the resulting data read from the stripes is XORed together by process 818, resulting in redundant parity data being written to the sixth drive 815. Thus, as is well known in the art, if any of disk drives 810 to 814 should fail it is possible to reconstitute the missing data by performing a XOR operation upon the remaining data. Thus, in the configuration shown in FIG. 8, it is possible for a damaged disk to be removed, replaced by a new disk and the missing data to be re-established by the XORing process. Such a procedure for the reconstitution of data in this way is usually referred to as disk healing.

A framestore may be configured in several different ways. For example, frames of different resolutions may be striped across different numbers of disks, or across the same number of disks with different size stripes. In addition, a framestore may be configured to accept only frames of a particular resolution, hard-partitioned to accept more than one resolution but in fixed amounts, dynamically soft-partitioned to accept more than one resolution in varying amounts or set up in any other way. In this embodiment striping is controlled by software within the editing system but it may also be controlled by hardware within each RAID.

The framestores herein described are examples of frame storage means. In other embodiments (not shown) the frame storage means may be any other system which allows storage of a large amount of image data and real-time access of that data by a connected image processing system.

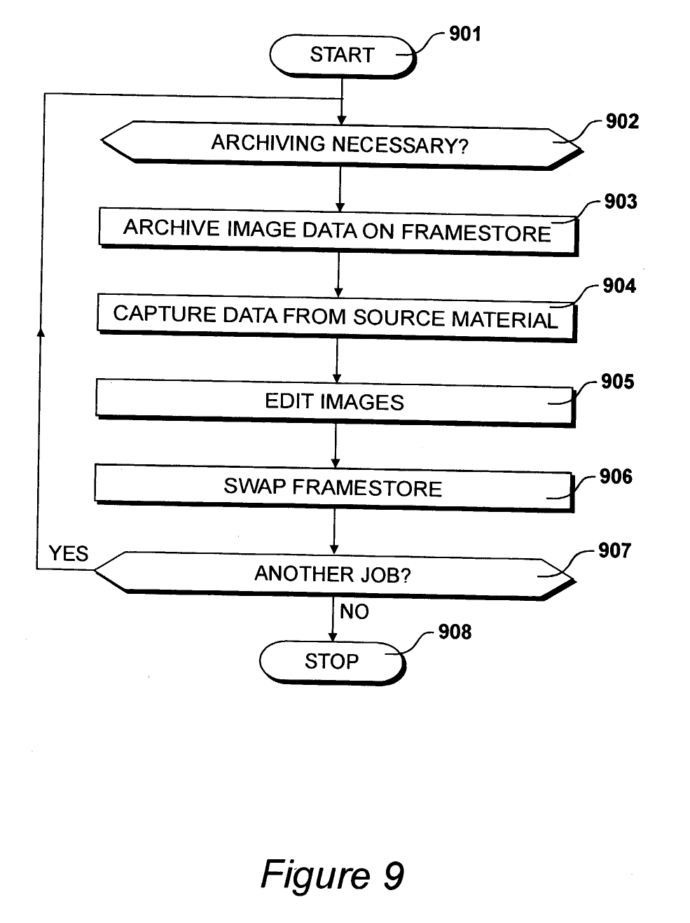

FIG. 9

The process shown in FIG. 8 is a method of storing frames of image data on a framestore. A framestore, however, is not a long-term storage solution, it is a method of storing frames which are currently being digitally edited. Each of framestores 111 to 116 has a capacity of over 1000 gigabytes but this is only enough to store approximately two hours' worth of high definition television frames and less than that of 8-bit film frames. When the frames have been edited to the on-line editor's satisfaction they must therefore be archived to videotape, CD-ROM or other medium. They may then be combined with other scenes in the film or television show, if necessary. Alternatively, over two hours of television-quality frames such as NTSC or PAL can be stored, but this must still be archived regularly to avoid overcrowding the available storage.

Frames are captured onto a framestore via an editing system, usually an off-line system. The framestore is then swapped with an on-line editing system and the editing of the frames is performed. The framestore is then swapped with an off-line editing system, not necessarily the same one as previously, and the frames are archived to make space for the next project.

FIG. 9 shows typical steps performed by an off-line editing system, such as system 101. At step 901 the procedure starts, and at step 902 a question is asked as to whether any archiving is necessary on editing system 101's local framestore, in this example framestore 111. If this question is answered in the affirmative then some or all of the image data saved on framestore 111 is archived to video, CD-ROM or other viewing medium.

At this point, and if the question asked at step 902 is answered in the negative, image data is captured to framestore 111 from the source material at step 904. Capturing of frames usually involves playing video or film and digitising it before storing it on a framestore. Alternatively, footage may be filmed in a digital format, in which case the frames are simply loaded onto the framestore.

At step 905 some preliminary off-line editing of the frames may be carried out before the framestore is swapped with another editing system, typically an on-line editing system such as system 103, at step 906. Such off-line editing may take the form of putting the clips of frames in scene order, for example.

At step 907 a question is asked as to whether another job is to be carried out. If this question is answered in the affirmative then control is returned to step 902. If it is answered in the negative then the procedure stops at step 908.

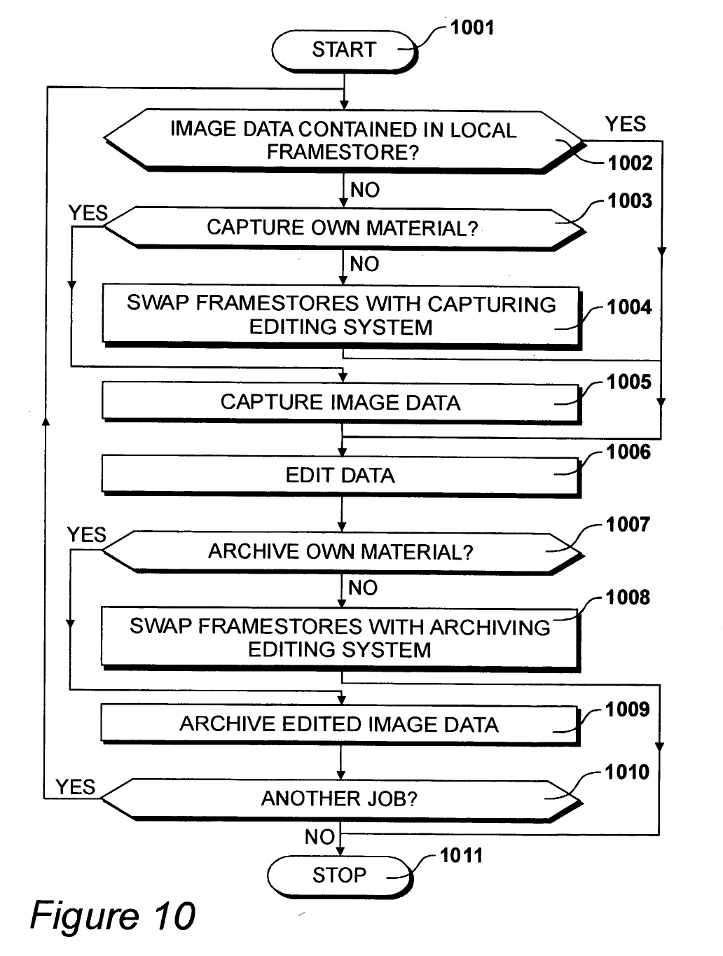

FIG. 10

FIG. 10 shows steps typically performed by an on-line editing system, such as system 103. At step 1001 the procedure starts and at step 1002 a question is asked as to whether the editing system is connected to the framestore containing the frames necessary to perform the current job. If this question is answered in the negative then at step 1003 another question is asked as to whether the user wishes to capture his own source material. If this question is answered in the negative then at step 1004 the on-line editing system swaps framestores with the editing system connected to the correct framestore, typically an off-line editing system which has just captured the required frames onto the framestore. If the question asked at step 1003 is answered in the affirmative then at step 1005 the on-line editing system captures the image data.

Usually only editing systems 105 or 106 would perform their own capturing and archiving of data, since they are not connected to patch panel 109 and are therefore unable to swap framestores. Editing systems 103 and 104 may also perform their own capturing and archiving of data but to gain maximum efficiency from the environment shown in FIG. 1 the framestores should be swapped instead.

At this point, and if the question asked at step 1002 is answered in the affirmative, control is directed to step 1006 where the image data is edited. At step 1007 a question is asked as to whether the system should archive its own material. If this question is answered in the negative then at step 1008 the on-line editing system swaps framestores with an off-line editing system which archives the edited frames. If it is answered in the affirmative then the frames are archived at step 1009.

At step 1010 a question is asked as to whether there is another job to be performed. If the question is answered in the affirmative then control is returned to step 1002. If it is answered in the negative then the procedure stops at step 1011.

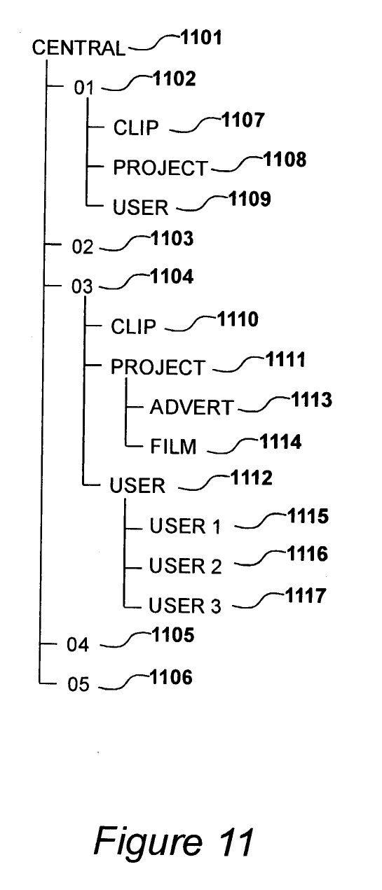

FIG. 11

The frames stored on a framestore, for example framestore 111, are not altered during the editing process, because editing decisions are often reversed as editors change their minds. For example, if a clip of frames shot from a distance were changed during the editing process to a close-up and the actual frames stored on the framestore were altered, the data relating to the outside portions of the frames would be lost. That decision could not then be reversed without re-capturing the image data. This is similarly true if, for example, a cut is to be changed to a wipe, or the scene handle is to be lengthened by a few frames. Over-manipulation of the images contained in the original frames, for example applying and then removing a colour correction, can also cause degradation in the quality of those frames.

Instead of altering the frames themselves, therefore, metadata is created. For each frame on framestore 111 data exists which is used to display that frame in a particular way and thus specifies effects to be applied. These effects could of course represent “special effects” such as compositing, but are often more mundane editing effects. For example, the metadata might specify that only a portion of the frame is to be shown together with a portion of another frame to create a dissolve, wipe or split-screen, or that the brightness should be lowered to create a fade.

An additional problem with the data stored on framestore 113 is that it is simply a number of images, without context or ordering. In order for this data to be used it must be considered as clips of frames. The metadata contains information relating each frame to a clip giving each frame's position within its clip. The editing and display of image data is performed in terms of clips, rather than in terms of individual frames.

When the frames are archived to another medium it is the displayed frames which are output, rather than the original frames themselves. Thus the metadata represents the entire creative input of the editors. If it is lost or corrupted the editing must be performed again. In prior art editing environments this metadata is stored on the hard drive of the editing system connected to the framestore. This creates problems, however, when the framestores are swapped because the metadata must also be swapped. Movement of data always carries a risk of data loss, for example if there is a power failure or data is simply corrupted by the copying procedure.

The solution presented by the present invention is to store the metadata on network storage system 107. The metadata is then accessed as necessary by the editing systems over Ethernet 132. In other embodiments (not shown) more than one network storage system could be used, either because the metadata is too large for a single system or as a backup system which duplicates the data.

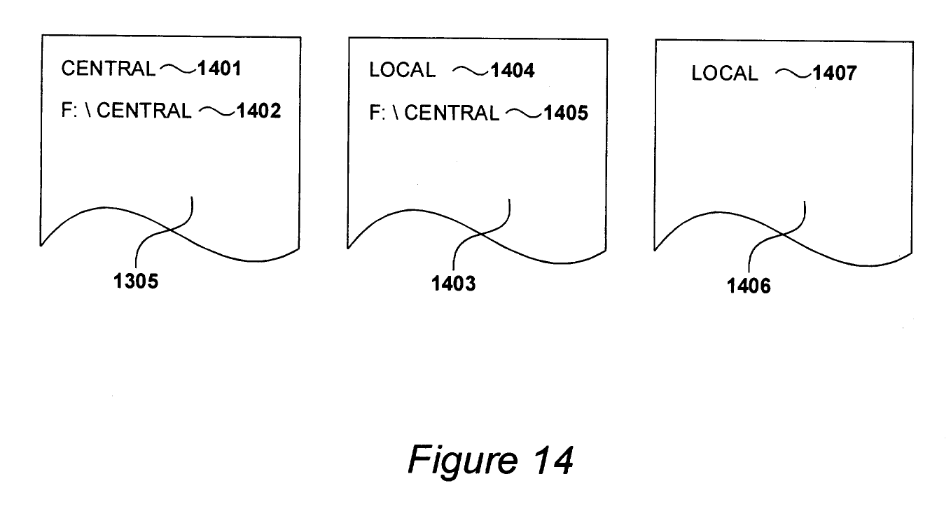

The structure of the metadata stored on network storage system 107 is shown in FIG. 11. Under the root directory CENTRAL 1101 there are five directories, each representing a framestore. Thus 01 directory 1102 represents framestore 111, 02 directory 1103 represents framestore 112, 03 directory 1104 represents framestore 113, 04 directory 1105 represents framestore 114, and 05 directory 1106 represents framestore 115. As will be explained with reference to FIG. 14, the metadata for framestore 116 is stored on on-line editing system 106 and therefore does not have a directory on network storage system 107.

Contained within each of directories 1102 to 1106 are three subdirectories. For example, in 01 directory 1102 are CLIP directory 1107, PROJECT directory 1108 and USER directory 1109. Within these subdirectories is stored all the metadata relating to framestore 111. In 03 directory 1104 are CLIP directory 1110, PROJECT directory 1111 and USER directory 1112, containing all the metadata relating to framestore 113. Directories 1103, 1104 and 1105 are shown unexpanded but also contain these three subdirectories.

The data stored in each CLIP directory contains information relating each frame to the clip, reel, desktop, clip library and project to which it belongs and its position within the clip. It also contains the information necessary to display the edited frames, for example cuts, special effects and so on, as discussed above. The metadata stored in each PROJECT directory lists the projects available on the framestore while the metadata stored in each USER directory relates to user setups within imaging applications.

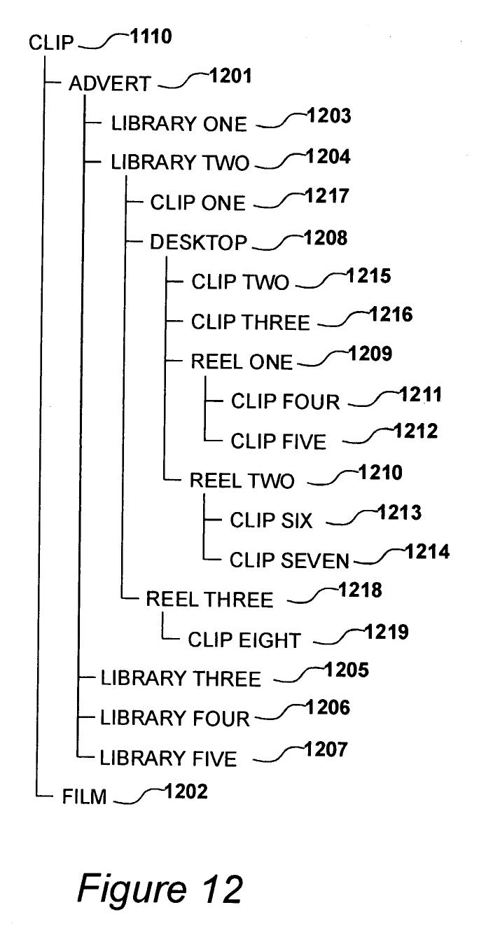

For example, PROJECT subdirectory 1111 and USER directory 1112 are shown expanded here. The contents of CLIP subdirectory 1110 will be described further in FIG. 12. As can be seen, PROJECT directory 1111 contains two subdirectories, ADVERT directory 1113 and FILM directory 1114. These directories relate to the projects stored on framestore 113. USER directory 1112 contains three subdirectories, USER 1 directory 1115, USER 2 directory 1116 and USER 3 directory 1117. These directories contain user set-ups for applications executed by the editing system controlling framestore 113, in this example editing system 103.

As can be seen, therefore, the path to the location of the metadata for a particular framestore varies only from the paths to the metadata for other framestores by the framestore ID. The metadata for framestore 116 stored on editing system 106 has a similar structure, with the subdirectories residing in a directory called 06, stored on system 106's hard drive.

FIG. 12

FIG. 12 details the contents of CLIP directory 1107, which describes the contents of framestore 111. Within framestore 111 frames are stored within projects, relating to different jobs to be done. For example, there may be image data representing a twenty-minute scene of a film and also other frames relating to a thirty-second car advertisement. These would be stored as different projects, as shown by ADVERT directory 1201 and FILM directory 1202. Clip libraries are set up within each project, representing different aspects of editing for the project. For example, within the advertisement project there may be a clip library for each scene. These are shown by directories 1203, 1204,1205, 1206 and 1207.

As an example, the contents of LIBRARY TWO directory 1204 is shown. A clip library may contain one or more desktops, as a way of organising frames in the library. Reel directories are stored within the desktop and clip files are stored within reel directories. In conventional video editing source material is received on reels. Film is then spooled off the reels and cut into individual clips. Individual clips are then edited together to produce an output reel. Thus storing clips within directories called reels provides a logical representation of original source material and this in turn facilitates maintaining a relationship between the way in which the image data is represented within the processing environment and its actual physical realisation. However, this logical representation need not be inflexible and so reel directories and clip files may also be stored directly within a library, and clip files may be stored directly within a desktop.

As an example, LIBRARY TWO directory 1204 contains DESKTOP directory 1208 which in turn contains REEL ONE directory 1209 and REEL TWO directory 1210. In this example, CLIP FOUR 1211 and CLIP FIVE 1212 are stored in REEL ONE directory 1209. Similarly, CLIP SIX 1213 and CLIP SEVEN 1214 are stored in REEL TWO directory 1210. Clip files can also be stored directly in DESKTOP directory 1208, as shown by CLIP TWO 1215 and CLIP THREE 1216, and directly in the clip library, as shown by CLIP ONE 1217. REEL THREE directory 1218 is stored directly in the clip library and contains CLIP EIGHT 1219.

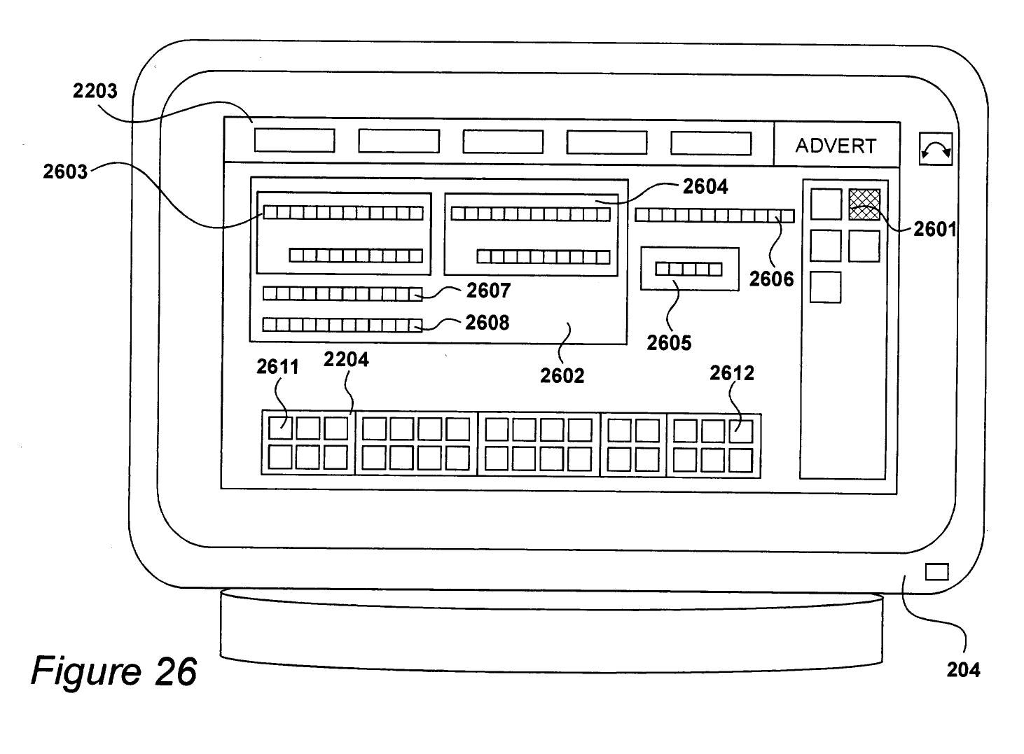

Each of the directories, that is the clip libraries, desktops and reel directories, only contain either more directories or clip files. There are no other types of files stored in a CLIP directory. Each item shown in FIG. 12 contains information identifying it as a clip library, desktop, reel directory or clip file. Each clip file shown in FIG. 12 is a collection of data giving the frame identifications of each frame within the clip, from which the physical location of the image data on the framestore that constitutes the frame can be obtained, the order in which the frames should be played and any special effects that should be applied to each frame. This data can then be used to display the actual frames stored on framestore 113. Hence while each clip is considered to be made up of frames and theoretically the frames should be the smallest item, the frames are not accessed individually. In order to use a single frame a user must cut and paste the frame into its own clip. This can be done in the user interface which will be described with reference to FIG. 26.

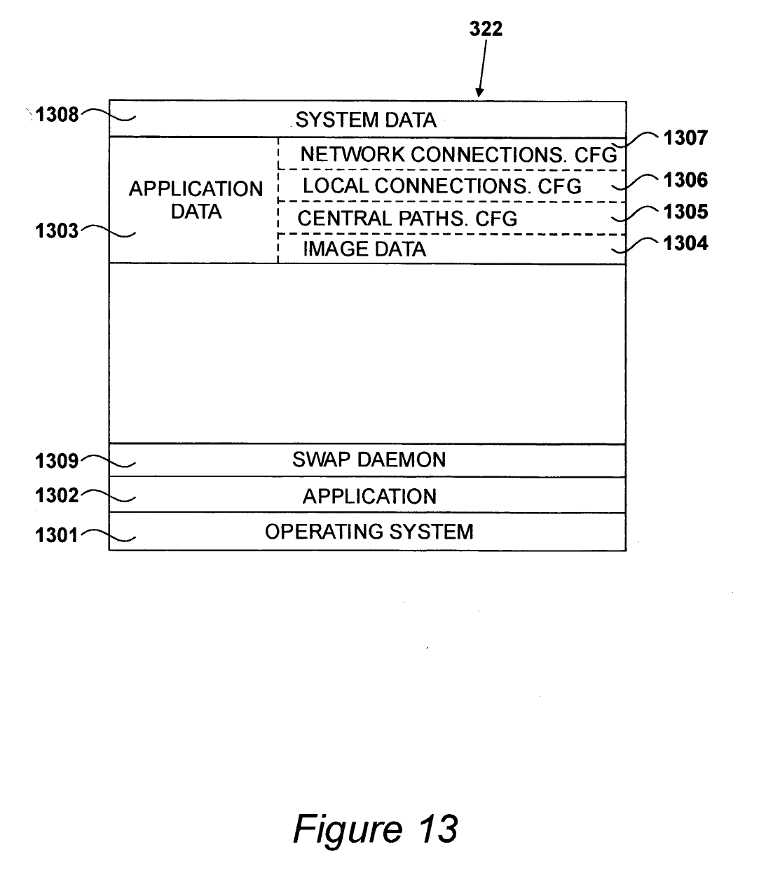

FIG. 13

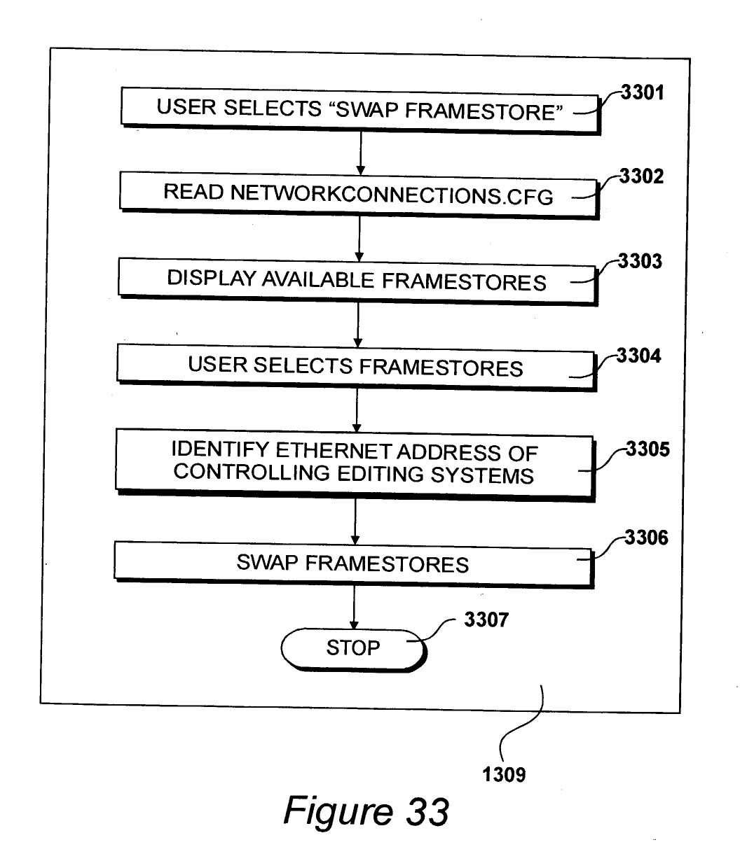

FIG. 13 illustrates the contents of memory 322 of on-line editing system 103. The operating system executed by the editing system resides in main memory as indicated at 1301. The image editing application executed by editing system 103 is also resident in main memory as indicated at 1302. A swap daemon is indicated at 1309. This daemon facilitates the swap of framestores and will be described further with reference to FIG. 33.

Application data 1303 includes data loaded by default for the application and other data that the application will process, display and or modify, specifically including image data 1304, if loaded, and three configuration files named CENTRALPATHS.CFG 1305, LOCALCONNECTIONS.CFG 1306 and NETWORKCONNECTIONS.CFG 1307. System data 1308 includes data used by the operating system 1301.

The contents of the memories of editing systems 101, 102 and 104 to 106 are substantially similar. Each may be running a different editing application most suited to its needs but the application data on each includes three configuration files similar to files 1305 to 1307.

FIG. 14

Configuration file 1305, named CENTRALPATHS.CFG, and two further versions of this file are shown in FIG. 14. This configuration file is used by an application to find the metadata for the editing systems' local framestore. An editing system which controls a framestore via patch panel 109 must keep its metadata centrally, ie on network storage system 107. Editing systems such as systems 105 and 106, which are directly connected to their respective framestores 115 and 116, may keep their metadata either centrally or locally, ie on their hard drive. In this example system 105 keeps its metadata centrally while system 106 keeps its metadata locally.

File 1305 contains two lines of data. The location of the metadata for editing system 103's local framestore is given by the word CENTRAL at line 1401, indicating that the metadata is stored on network storage system 107. The path to that metadata is indicated at line 1404. In this example the F:\ drive has been mapped to network storage system 107 and CENTRAL directory 1101 is given. In other embodiments (not shown) where there is more than one network storage system there may be more than one path indicated in this file. Editing systems 101, 102, 104 and 105, which also have their metadata stored centrally, all have an identical configuration file named CENTRALPATHS.CFG.

File 1403 is the file named CENTRALPATHS.CFG in the memory of editing system 106, which keeps the metadata for framestore 116 on its own hard drive. This is indicated by the word LOCAL at line 1404. It can however view the metadata of framestores 111 to 115 in order to request wire transfers, and thus the path to network storage system 107 is given at line 1405.

A third possibility for the configuration file is given by file 1406. This simply contains the word LOCAL at line 1407 and no further information. This is the file which would be resident in the memory of a system (not shown) which keeps its local framestore's metadata on its own hard drive and is not able to access frames on any other framestores, either because it is not linked to a network or because access has for some reason been disabled.

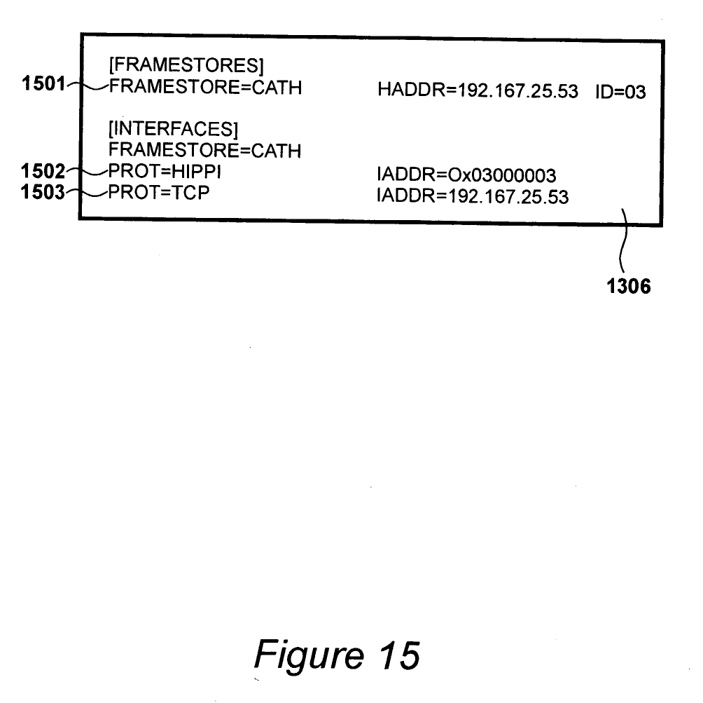

FIG. 15

FIG. 15 details configuration file 1306, named LOCALCONNECTIONS.CFG. For any of image processing systems 101 to 106, a similar file gives its network connections and identifies the local framestore. The file illustrated in FIG. 15 is in the memory of on-line editing system 103, which for example currently controls framestore 113. Line 1301 therefore gives the information relating to framestore 113. CATH is the name given to framestore 113 to make distinguishing between framestores easier for users, HADDR stands for Hardware Address, which is the Ethernet address of editing system 103 which controls the framestore, and the ID, 03, is the framestore identification reference (framestore ID) of framestore 113.

Lines 1502 and 1503 give information about the interfaces of editing system 103 and the protocols which are used for communication over the respective networks. As shown in FIG. 1, in this embodiment all the editing systems are connected to the Ethernet 131 and on-line editing systems 103 to 106 are also connected by a HiPPI network 132. Line 1502 therefore gives the address of the HiPPI interface of processing system 103 and line 1503 gives the Ethernet address.

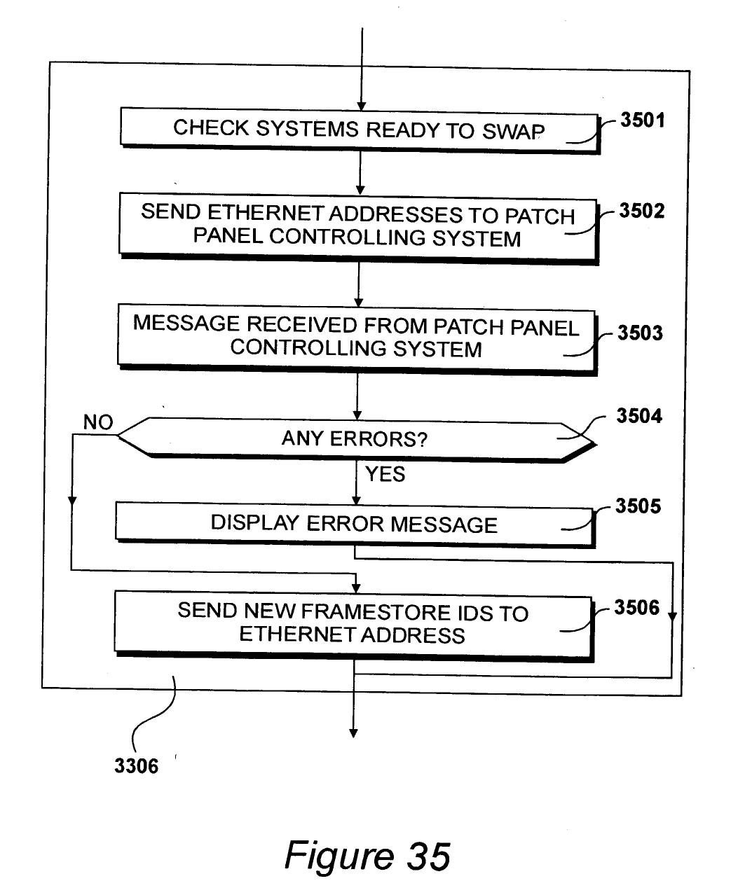

If editing system 103 swaps framestores with another editing system then it receives a message containing the ID of the framestore it now controls, as will be described with reference to FIG. 35. The name of the framestore and the ID shown in file 1306 are then changed to reflect the new information.

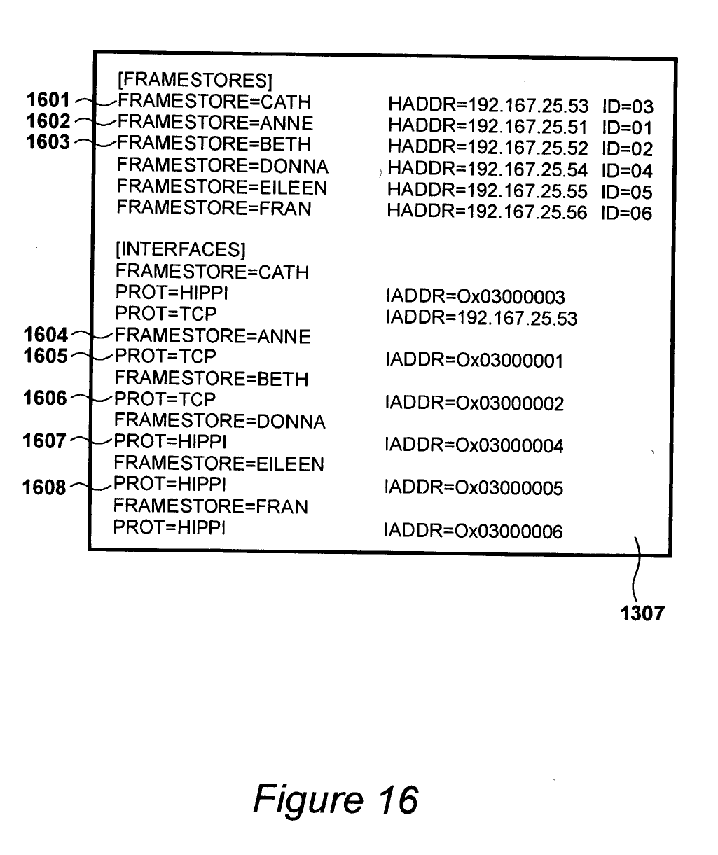

FIG. 16

Each of image processing systems 101 to 106 multicasts the data contained in its file named LOCALCONNECTIONS.CFG whenever the editing system is switched on or the file changes. The other editing systems use these multicasts to construct, in memory, a configuration file named NETWORKCONNECTIONS.CFG. FIG. 16 illustrates configuration file 1307, which is the file named NETWORKCONNECTIONS.CFG on on-line editing system 103.

The first framestore, at line 1601, is CATH, which FIG. 15 showed as framestore 113 connected to processing system 103. Line 1602 indicates framestore ANNE which has ID 01. This is framestore 111. Line 1602 also gives the Ethernet address of the editing system controlling framestore 111, which is currently system 101. Line 1603 indicates framestore BETH, which has ID 02, and the Ethernet address of its controlling editing system.

Lines 1604 and 1605 give the interface information for editing system 103, listed under CATH because that is the framestore which it currently controls, as in FIG. 15. Line 1606 gives interface information for the editing system controlling ANNE and line 1607 gives interface information for the editing system controlling BETH.

Only one interface is described for each editing system (except the editing system on which the configuration file resides, in this case 103). The interface given is the one for the fastest network which both editing system 103 and the editing system controlling the respective framestore support. Since all of image processing systems 101 to 106 are connected to the HiPPI network this is the interface given.

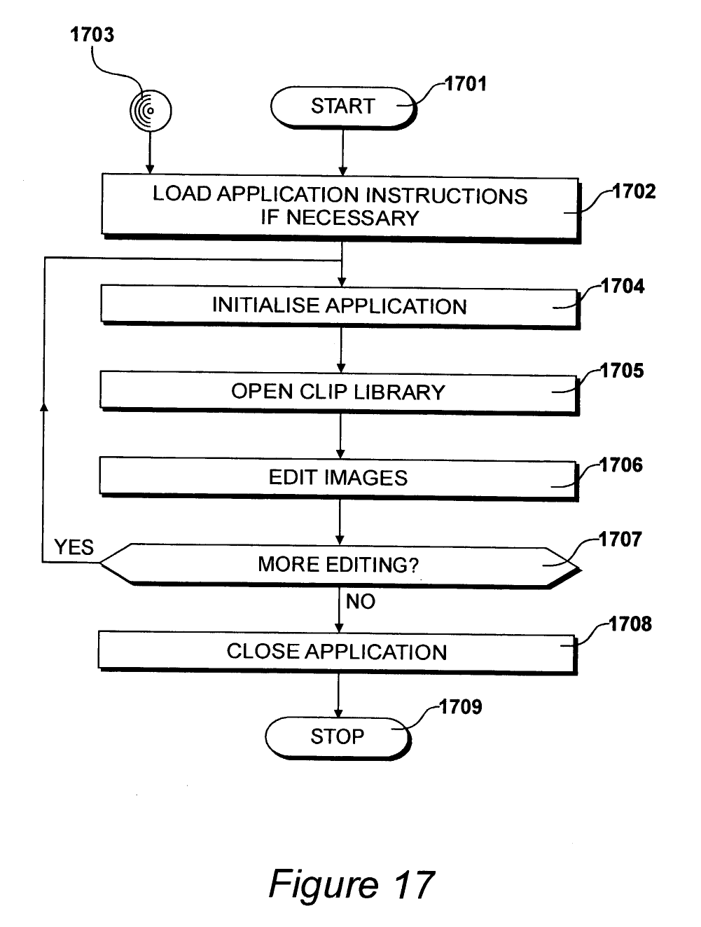

FIG. 17

FIG. 17 illustrates steps required to execute an application running on, for example, on-line editing system 103. These are generic instructions which could relate to any imaging application run by any of image processing systems 101 to 106, each of which may be executing an application more suitable for certain tasks than others. For example, off-line editing systems 101 and 102 execute applications which streamline the capturing and archiving of image data and include only limited image editing features. While on-line editing systems 103 to 106 each have the same capabilities, each may be running an application biased towards a slightly different aspect of editing the data, with a more limited image capturing and archiving facilities.

At step 1701 the procedure starts and at step 1702 application instructions are loaded if necessary from CD-ROM 1703. At step 1704 the application is initialised and at step 1705 a clip library containing the frames to be edited is opened and at step 1705 these frames are edited.

At step 1706 a question is asked as to whether more frames are to be edited, and if this question is answered in the affirmative then control is returned to step 1705 and another clip library is opened. If it is answered in the negative then control is directed to step 1707 where the application is closed. The process then stops at step 179.

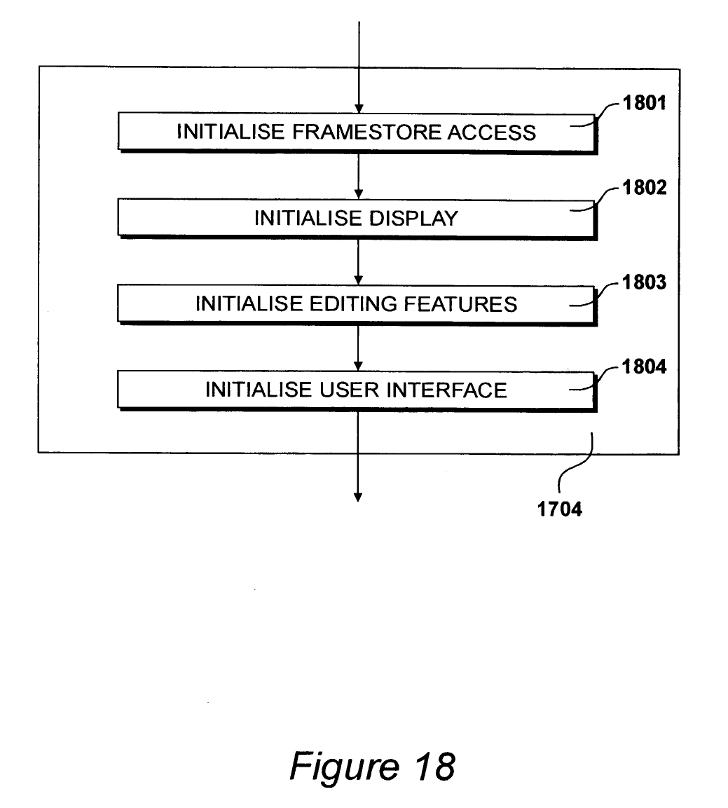

FIG. 18

FIG. 18 details step 1704 at which application 1302 is initialised. At step 1801 information necessary to access the framestore controlled by editing system 103 is obtained and at step 1802 the display of the application is initialised according to user settings. At step 1803 the various editing features of the application are initialised and at step 1804 a user interface which displays the contents of the framestore which editing system 103 controls is initialised.

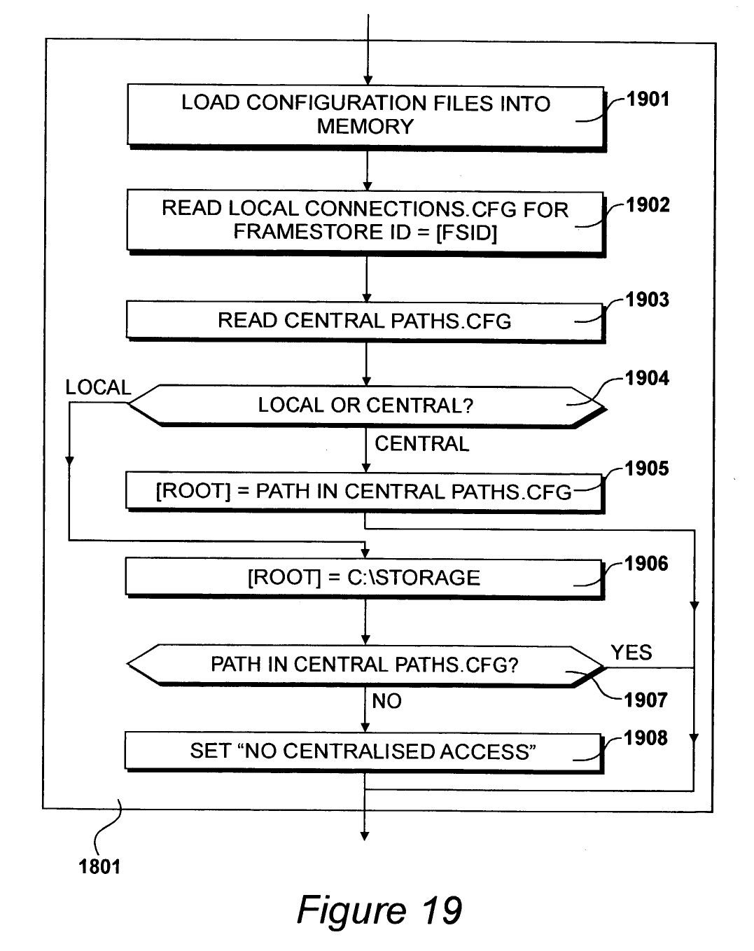

FIG. 19

FIG. 19 details step 1801 at which the framestore access is initialised. At step 1901 configuration files 1305 to 1307 are loaded into the memory 322 of editing system 103. At step 1902 configuration file 1306 is read to identify the framestore ID of the framestore controlled by editing system 103. In the current example this ID is 03. This is identified by the tag FSID. At step 1903 configuration file 1305 is read and at step 1904 a question is asked as to whether the first line in configuration file 1305 reads LOCAL or CENTRAL. If the answer is CENTRAL then at step 1905 a tag ROOT is set as the path to network storage system 107 given in configuration file 1305, in this example F:\CENTRAL. If the answer is LOCAL then at step 1906 the tag ROOT is set to be C:\STORAGE. In this example the application is executed by editing system 103, and so the first line of configuration file 1305 reads CENTRAL, but when applications are initialised on editing system 106 the answer to this question will be LOCAL. The metadata for framestore 116 must therefore be stored at the location given by this initialisation process.

It will be appreciated by the skilled reader that the mapping of drives given here as C:\ and F:\ is an example of the way in which the file CENTRALPATHS.CFG indicates the local or central nature of the storage. Other methods of indicating and accessing locations of data may be used within the invention.

At step 1907 a question is asked as to whether a path is given in configuration file 1305. If this question is answered in the negative then at step 1908 a flag “NO CENTRALISED ACCESS” is set. Thus if an editing system cannot access any framestore apart from its own, this is noted during initialisation of process 1801. At this point, and if the question asked at step 1907 is answered in the affirmative, and when step 1905 is concluded, step 1801 is complete.

When framestore access initialisation step 1801 is concluded, the basic path to the metadata for the local framestore has been logged along with the ID of the framestore, and whether or not it is possible to access metadata for other framestores has also been logged.

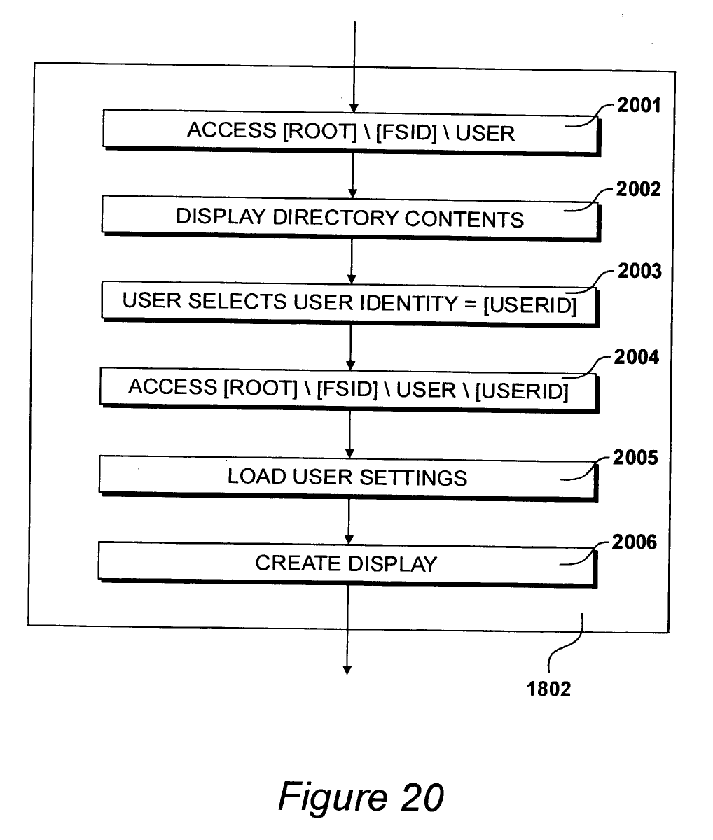

FIG. 20

FIG. 20 details step 1802, at which the display of application 1302 is initialised. At step 2001 the USER directory in the metadata is accessed. Since this application is running on editing system 103, which in this example controls framestore 113, the directory accessed here is USER directory 1112 within 03 directory 1104. The contents of this directory are displayed to the user at step 2002. These contents are a list of further directories, each corresponding to a user identity.

At step 2203 the user selects one of these identities and the directory name is tagged as USERID. For example, the user may choose USER 1 subdirectory 1115. At step 2004 the selected subdirectory is accessed and at step 2005 the user settings contained therein are loaded. At step 2006 the display of application 1302 is initialised according to stored instructions and these user settings.

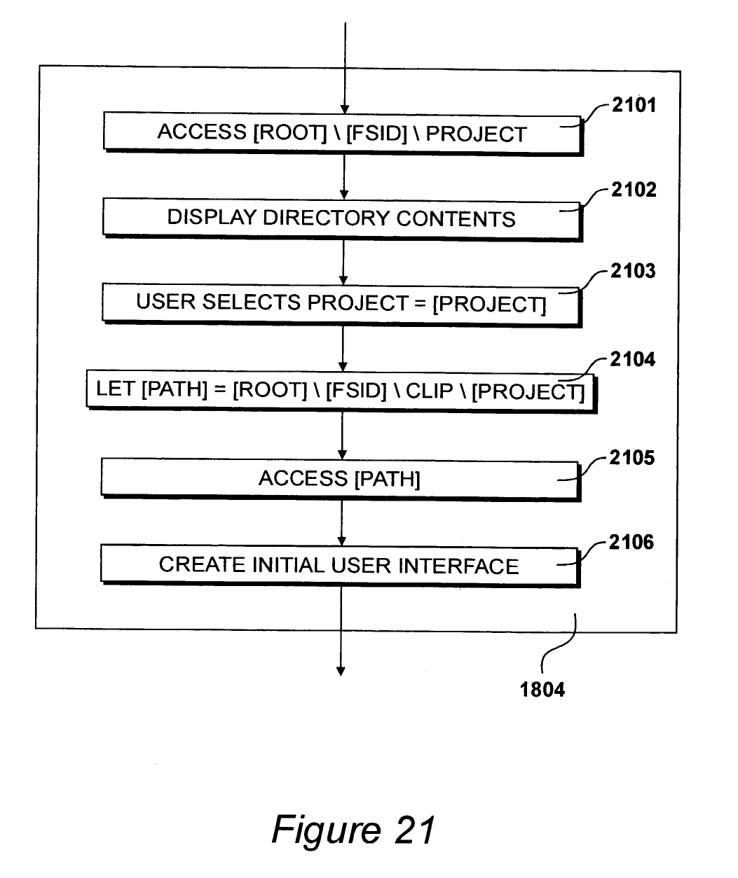

FIG. 21

FIG. 21 details step 1804 at which the user interface of application 1302 is initialised. AT step 2101 the PROJECT directory of the metadata is accessed. In this example this is directory 1111. At step 2102 the contents of this directory are displayed to the user, which comprise a list of projects stored on the framestore.

At step 2103 the user selects one of these projects and the directory name is given the tag PROJECT. At step 2104 a tag PATH is set to be the location of the clip libraries belonging to that project, resident within the CLIP directory of the metadata. In this example, this is CLIP directory 1110 within 03 directory 1104, and supposing the user had selected ADVERT as the required project, the tag PATH would be set as the location of ADVERT directory 1201. At step 2105 this directory is accessed and at step 2106 its contents are used to create the initial user interface.

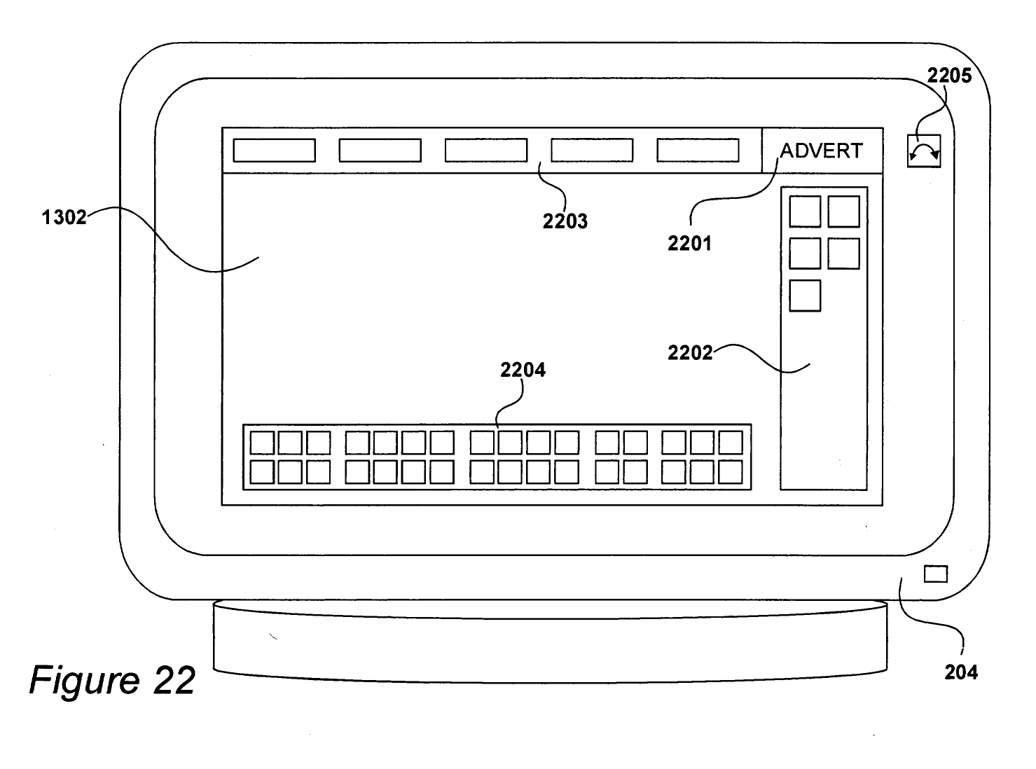

FIG. 22

FIG. 22 illustrates the initial user interface. Application 1302 is shown displayed on monitor 204 of on-line editing system 103. Tag 2201 in the top right hand corner indicates the project selected and the clip libraries within that project are indicated at 2202. Each icon at 2202 represents a directory listed in the ADVERT directory 1201 within CLIP directory 1101 and each icon links to the metadata location of that directory. Menu buttons 2203 and toolbars 2204 have been initialised, although most of the functions require a clip to be selected before they can be used. Icon 2205, outside application 1302, may be selected to initiate a swap of framestores. This will be described further with reference to FIG. 35.

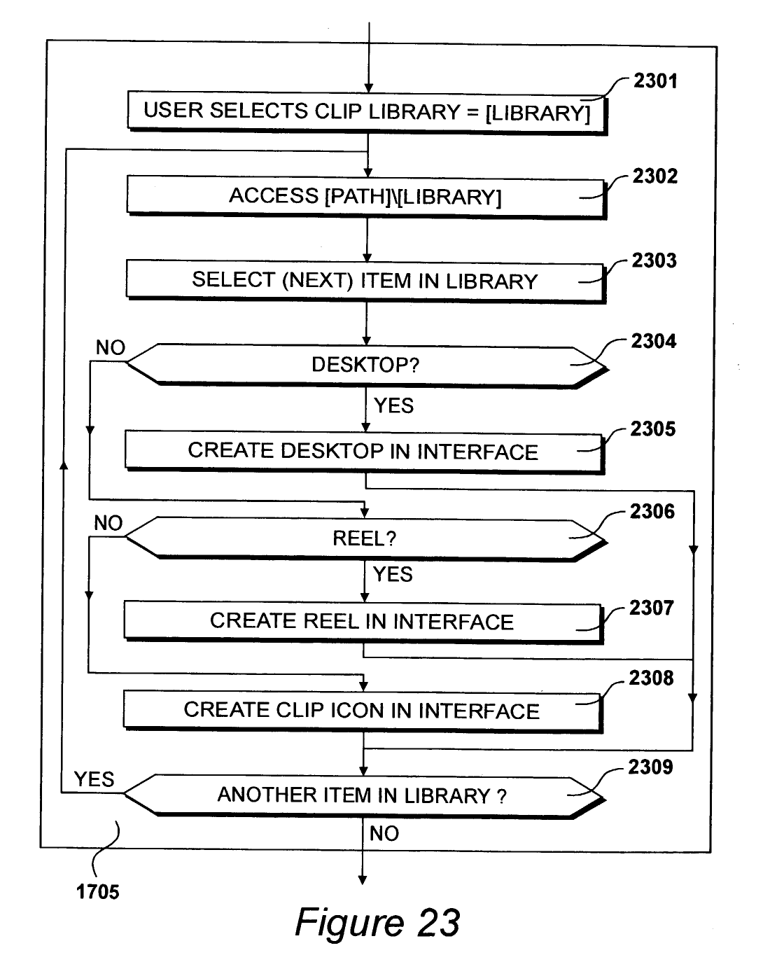

FIG. 23

FIG. 23 details step 1705 at which a clip library is selected. At step 2301 the user selects one of the clip libraries indicated by icons 2202 and at step 2302 the metadata for that clip library is accessed. For example, LIBRARY TWO directory 1204 may be accessed at this step.

At step 2303 the first item in this directory is selected and at step 2304 a question is asked as to whether this item is a desktop. If the question is answered in the affirmative then at step 2305 a desktop is created in the user interface shown in FIG. 22. If the question is answered in the negative then at step 2306 a question is asked as to whether the item is a reel. If this question is answered in the affirmative then at step 2307 a reel is created in the interface, while if it is answered in the negative then at step 2308 a clip icon is created in the interface. At this point, and also following steps 2305 and 2307, the question is asked as to whether there is another item in the selected library directory. If the question is answered in the affirmative then control is returned to step 2303 and the next item is selected. If it is answered in the negative then step 1705 is complete.

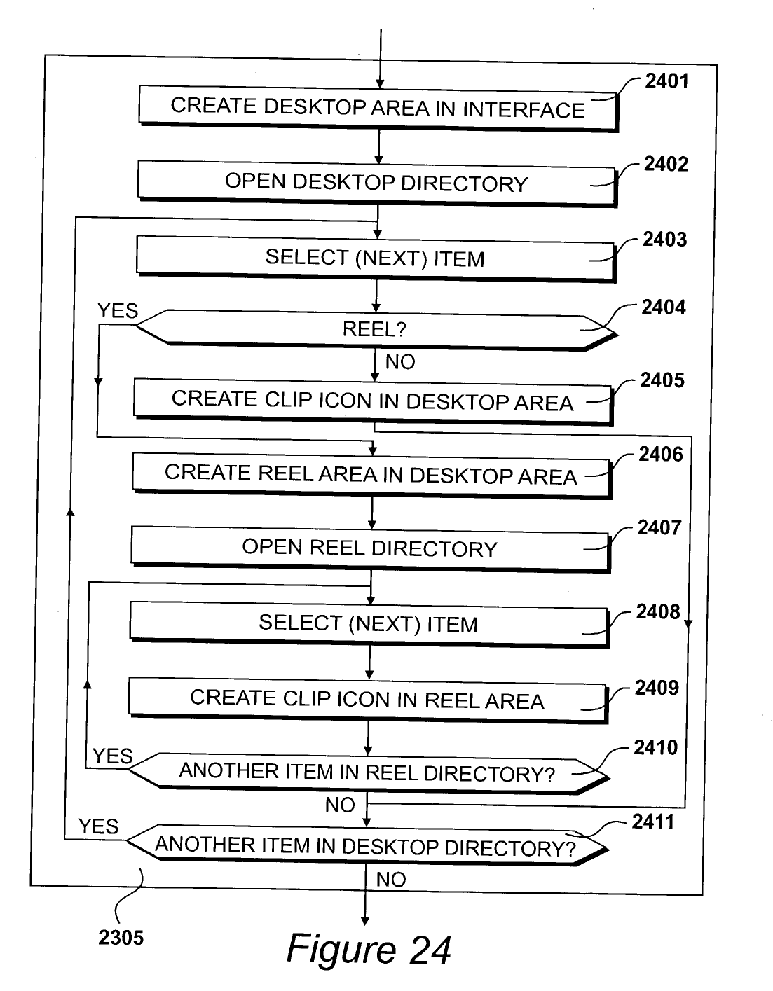

FIG. 24

FIG. 24 details step 2305 at which a desktop is created in the interface. At step 2401 a desktop area is created in the interface and at step 2402 the desktop directory is opened. For example, if the item selected at step 2303 is DESKTOP directory 1208 then at this step that directory is opened.

At step 2403 the first item in this directory is selected and at step 2404 a question is asked as to whether it is a reel. If this question is answered in the negative then a clip icon is created in the desktop area at step 2405.

If the question asked at step 2404 is answered in the affirmative then at step 2406 a reel area is created in the desktop area. At step 2407 the reel directory is opened and at step 2408 the first item in the directory is selected. At 2409 a clip icon corresponding to this item is created in the reel area and at step 2410 a question is asked as to whether there is another item in this reel directory. If the question is answered in the affirmative then control is returned to step 2408 and the next item is selected if it is answered in the negative then all clips within this reel have had icons created and at this point, and following step 2405, a question is asked as to whether there is another item in the desktop directory. If this question is answered in the affirmative then control is returned to step 2403 and the next item is selected. If it answered in the negative then the desktop has been fully created.

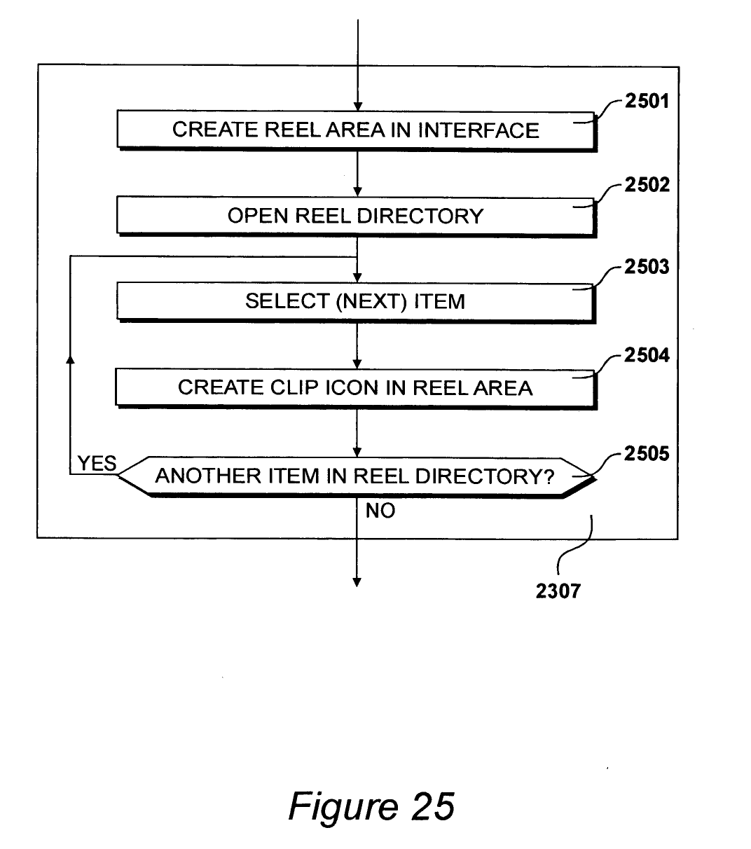

FIG. 25

FIG. 25 details step 2307 at which a reel is created in the interface. At step 2501 a reel area is created in the interface and at step 2502 the reel directory is opened. At step 2503 the first item in this directory is selected and at step 2504 a clip icon corresponding to this item is created. At step 2505 a question is asked as to whether there is another item in this reel directory and if it is answered in the affirmative then control is returned to step 2503 and the next item is selected. If it is answered in the negative then the reel has been fully created in the interface.

FIG. 26

FIG. 26 illustrates the result of the steps carried out in FIG. 23 to create a user interface for an opened clip library. In this case, the open clip library is LIBRARY TWO directory 1204, as indicated by the shading of icon 2601. Thus the interface contains a desktop 2602, which in turn contains two reels 2603 and 2604. These are representations of DESKTOP directory 1208, REEL ONE directory 1209 and REEL TWO directory 1210. Similarly, reel 2605 is a representation of REEL THREE directory 1218. Each clip icon represents a clip of frames stored on framestore 113. Thus, clip 2606 represents the clip whose metedata is stored in CLIP ONE file 1217, clip icons 2607 and 2608 represent the clips whose metadata are stored in CLIP TWO file 1215 and CLIP THREE file 1216 respectively, and so on. Each clip icon links to the metadata location of the clip file which it represents.

By selecting one or more of these clips and using functions accessed via menu bar 2203 or toolbars 2204 the clips may be edited. The clips may also be moved within the user interface shown in FIG. 26 so as to reside within a different desktop or reel. This results in the metadata within LIBRARY TWO directory 1204 also being moved. For example, if the user were to drag clip 2606 to within reel 2605, this would have the effect of moving CLIP ONE directory 1217 to within REEL THREE directory 1218.

When the user has finished editing the frames associated with this clip library she may either close the application or select another clip library, thus answering the question asked at step 1707 as to whether more frames are to be edited. If another clip library is opened then step 1705 detailed in FIG. 23 is repeated and a new user interface is created. As previously described, if the user wishes to access a different project the application must be closed and restarted.

The editing functions accessed via menu bar 2203 and toolbars 2204 are specific to application 1302, and other applications have different editing features. However, two particular toolbar buttons are common to all applications run by image processing systems 101 to 106. Button 2611 displays a selected clip to the user. On on-line editing system 103, this will be displayed on broadcast quality monitor 205, while on off-line editing system 101 it will be shown on monitor 403, either replacing the display of the application for a short time or within a window. Button 2612 allows the user of on-line editing system 103 to request a wire transfer of remote frames from editing systems 101, 102 and 104 to 106. The frames may then be transferred over HiPPI network 131 for storage on framestore 113.

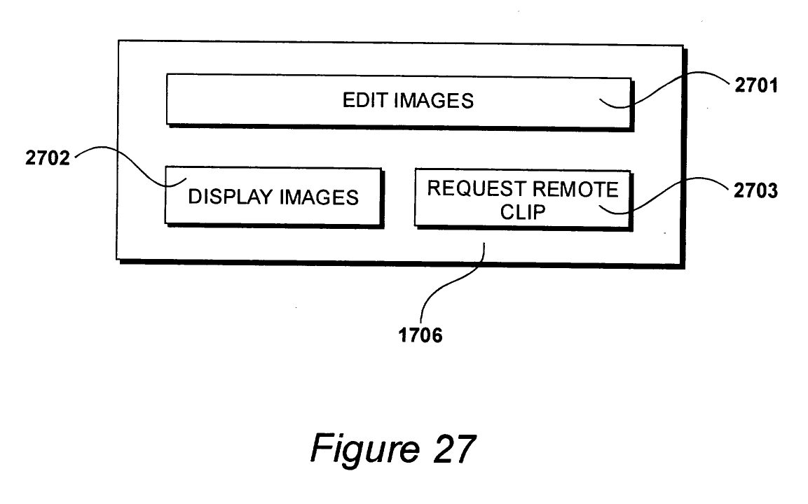

FIG. 27

FIG. 27 shows functions carried out at step 1706. The editing functions available to the user of on-line editing system 103 are shown generally at 2701. The two functions common to all applications run by image processing systems 101 to 106 are shown by the “display clip” function 2702 and “request remote frames” function 2703.

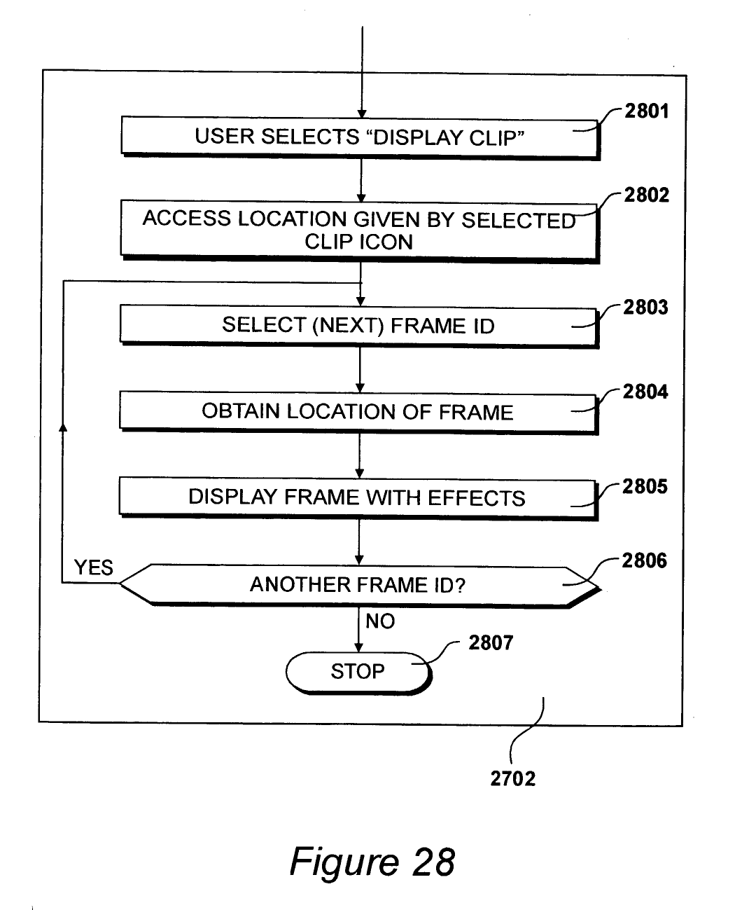

FIG. 28

FIG. 28 details thread 2402. At step 2801 the function starts when the user selects “display clip” button 2611 while a clip icon is selected. At step 2802 the metadata location given by the selected clip icon is accessed. For example, if the user had selected clip icon 2607 the application would now access CLIP TWO file 1215.

At step 2803 the frame ID of the first frame is selected and at step 2804 the physical location of the image data constituting this frame on framestore 113 is obtained. At step 2805 the frame is displayed to the user complete with any special effects specified in the metadata and at step 2806 the question is asked as to whether there is another frame ID within the metadata. If this question is answered in the affirmative then control is returned to step 2803 and the next frame ID is selected. If it is answered in the negative then the function stops at 2807 since all the frames have been displayed.

The data indicating the physical location of the image data on framestore 113 that constitutes the frame is in this embodiment stored in a small area of framestore 113 itself. However, in other embodiments (not shown) this data may be stored on network storage system 107 or in any other location. This data is simply an address book for the framestore and is of no use without the metadata for that framestore. Framestore 113 contains a jumble of frames and it is only by using the information contained in the metadata stored within CLIP directory 1110 that the frames can be presented to the user as clips of frames.

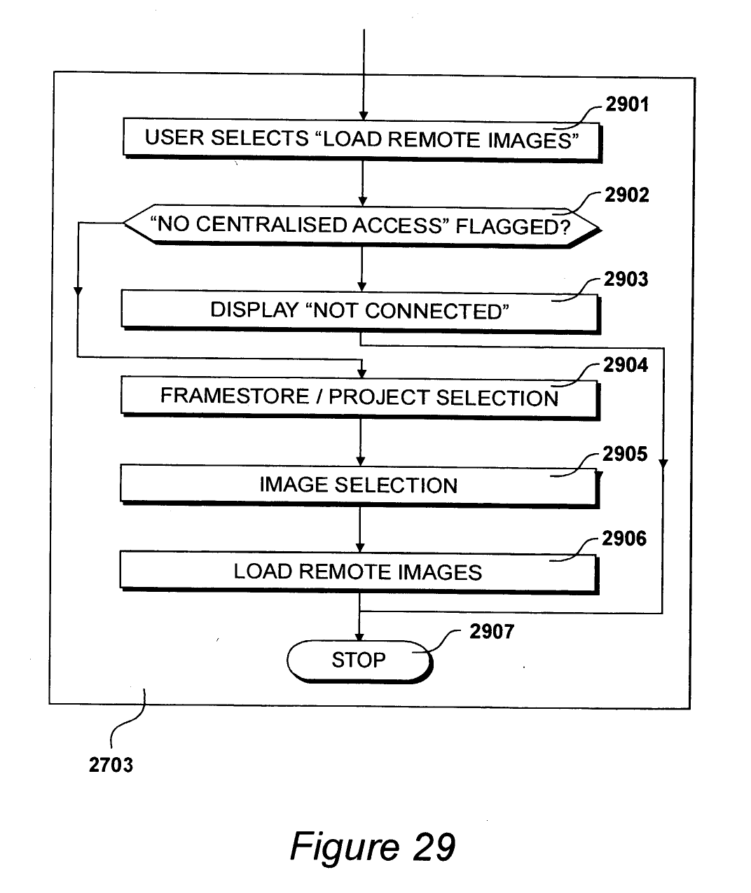

FIG. 29

FIG. 29 details function 2403 at which frames stored on a remote framestore are requested. At step 2901 the function starts when the user selects button 2612. At step 2902 a question is asked as to whether the flag “NO CENTRALISED ACCESS” is set. This flag is set at step 1908 if an editing system does not have access to network storage system 107. Hence, if this question is answered in the affirmative then the message “NOT CONNECTED” is displayed to the user at step 2903. However, if the question is answered in the negative then at step 2904 the user selects the framestore and then the project to which the clip she requires belongs.

At step 2905 the user selects the specific clip of frames that she requires and at step 2906 loads the frames remotely. The function stops at step 2908.

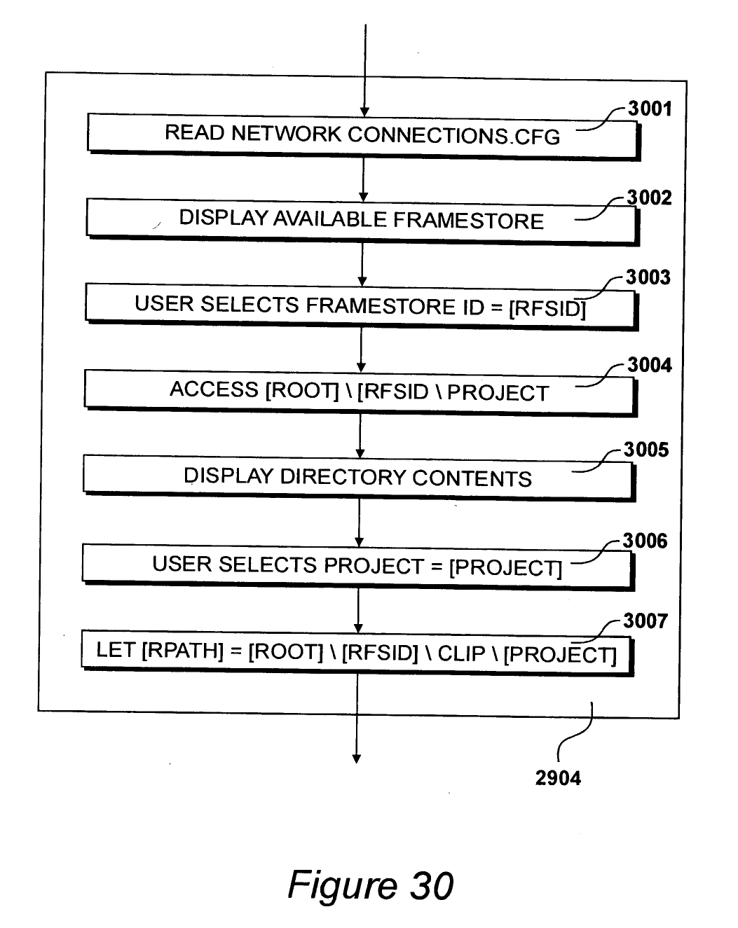

FIG. 30

FIG. 30 details step 2904 at which the user selects the framestore and project to access remotely. At step 3001 configuration file 1307 is read to identify the available framestores on the network and at step 3002 a list of these framestores is displayed to the user. At step 3003 the user selects one of these framestores and its ID is given the tag RFSID.

At step 3004 the relevant PROJECT directory is accessed. For example, if the user had selected framestore ID 01 at step 3003 PROJECT directory 1108 would now be accessed. At step 3005 the contents of this directory are displayed to the user and at step 3006 the user selects a project. This is given the tag RPROJECT. At step 3007 a tag RPATH is set to be the location of the clip libraries in that project on that framestore.

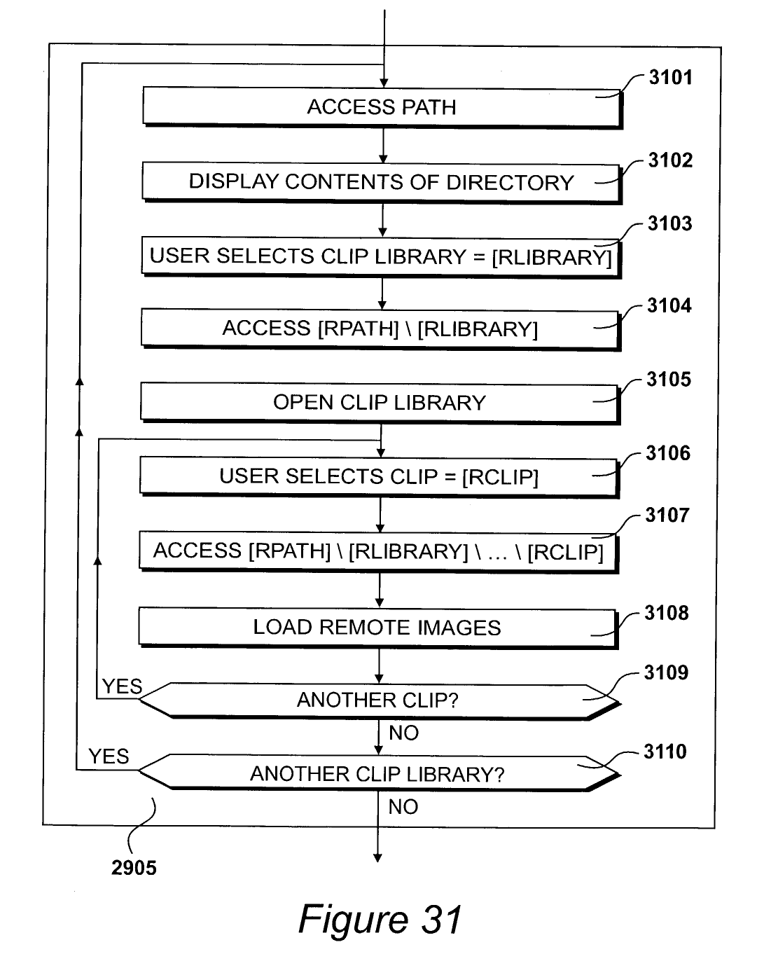

FIG. 31

FIG. 31 details step 2905 at which the user selects a particular clip to be remotely loaded. At step 3101 the directory containing the clip library subdirectories for the selected project is accessed and at step 3102 a list of these subdirectories is displayed to the user. At step 3103 the user selects a clip library and this is given the tag RLIBRARY. At step 3104 this clip library is accessed and at step 3105 a user interface is created to display the contents of the clip library to the user, in the same way as at step 1705 detailed in FIG. 23.

At step 3106 the user selects a clip which is given the tag RCLIP and at step 3107 the metadata for that clip is accessed. At step 3108 the clip is loaded and at step 3109 the question is asked as to whether another clip from the same library is to be loaded. If this question is answered in the affirmative then control is returned to step 3106 and another clip is selected. If it is answered in the negative then at step 3110 a question is asked as to whether another clip library is to be selected. If this question is answered in the affirmative then control is returned to step 3101 where the list of clip libraries is again accessed and displayed to the user. If the question is answered in the negative then step 2905 is concluded.

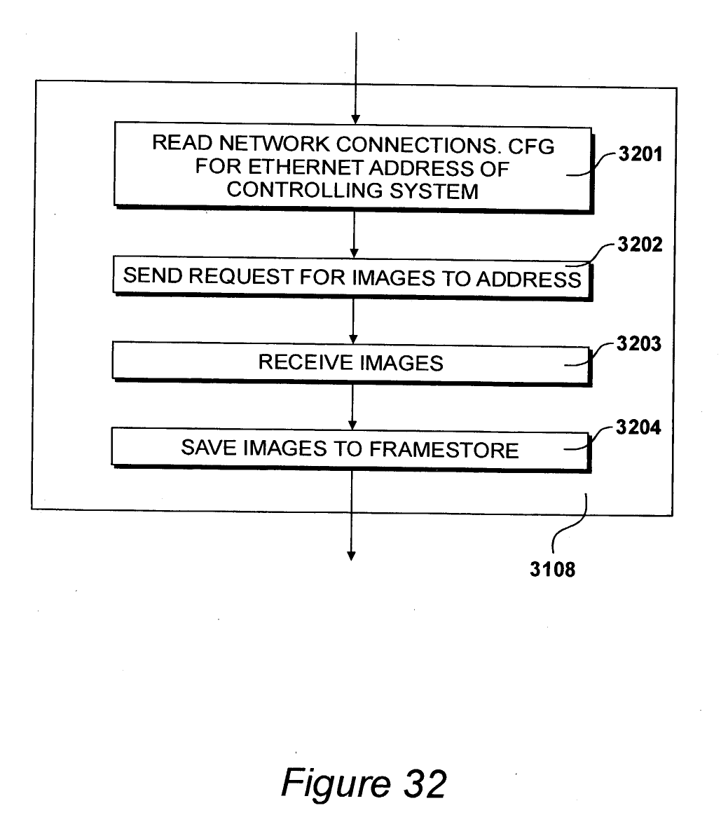

FIG. 32

FIG. 32 details step 3108 at which the remote frames are loaded. At step 3201 configuration file 1307 is read to identify the address of the editing system controlling the framestore with the ID identified at step 3003. In this example, framestore 111 has been selected which is controlled by editing system 101. At step 3202 requests for the selected frames are sent to the HiPPI address. Each request contains a frame ID obtained from the metadata accessed at step 3107 and the frames are requested in the order specified in that metadata.

At step 3203 the frames are received over HiPPI network 131 one at a time and at step 3204 they are saved to the framestore controlled by editing system 103, in this example framestore 113.

Requests for transfers of frames are received by a remote editing system, queued and attended to one by one. The remote system accesses each frame in the same way as if it were displaying the frame on its own monitor, however instead of displaying the data it sends it to the requesting processing system. If the remote system is currently accessing its own framestore then these requests will not be allowed to jeopardise this real-time access required by the remote system. For this reason the requested frames are sent one by one and not in real time.

When the requesting system, in this case editing system 103, receives the frames they are saved to the framestore, in this example framestore 113, in the same way as if the frames had been captured locally. The location data identifying the location of the image data on the framestore that constitutes the frame is updated and the user of editing system 103 can now access the frames as a clip by opening the clip library in which it is stored.

FIG. 33

FIG. 33 details the function that is started when swap button 2205 is selected by the user. This starts the function as shown by step 3301. At step 3302 configuration file 1307 in memory is examined to identify all the framestores currently available on the network. A user interface, as shown in FIG. 35, is then displayed to the user at step 3303. At step 3304 the user selects the two framestores she wishes to swap. These need not include the framestore local to her editing system, since a swap can be initiated by an editing system that is not involved. At step 3305 the Ethernet addresses of the editing systems controlling the two framestores to be swapped are identified from configuration file 1307 and at step 3306 the swap is carried out. At step 3307 the function stops.

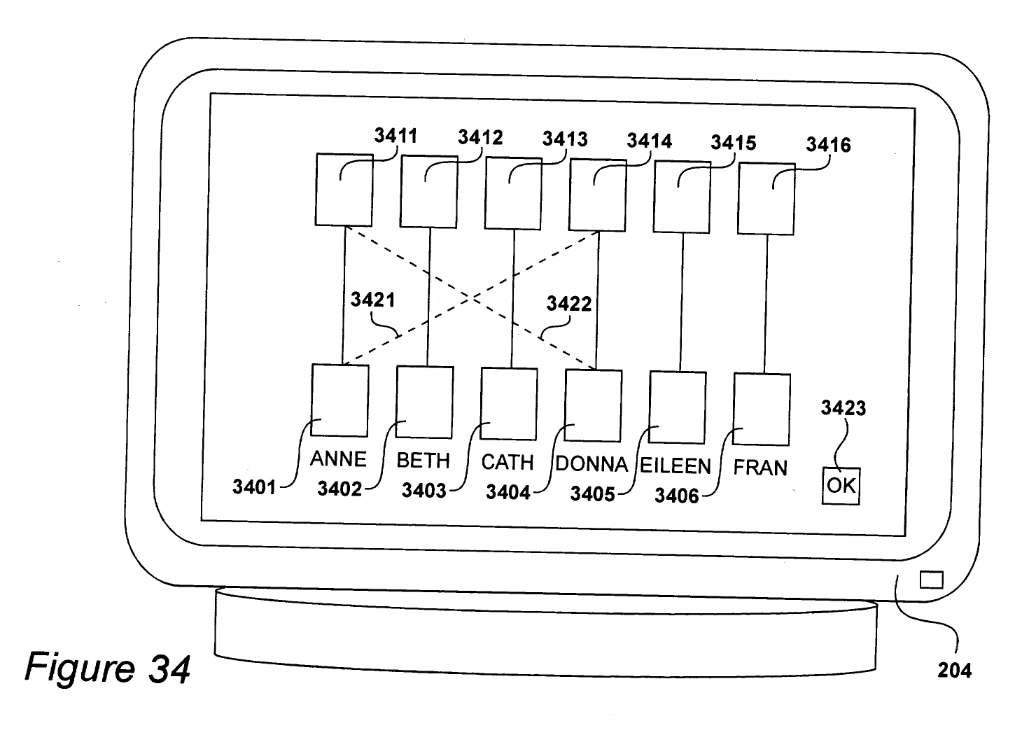

FIG. 34

The user interface displayed to the user on selection of button 2205 is illustrated in FIG. 34. Configuration file 1307, as shown in FIG. 16, has been discovered and the six framestores on the network have been identified. These are shown by icons 3401, 3403, 3403, 3404, 3405 and 3406, representing framestores 111 to 116 respectively. Each is shown connected to an editing system, illustrated by icons 3411, 3412, 3413, 3414, 3415 and 3416. These represent image processing systems 101 to 106. In the current example each image processing system is connected to the framestore directly opposite it in FIG. 1, and so icons 3411 to 3414 represent editing systems 101 to 104 respectively. However, at any one time this may not be the case since any of framestores 111 to 114 can be controlled by any of editing systems 101 to 104. No information is given in the interface as to which editing system is which, since this information is not contained within configuration file 107.

Editing systems 105 and 106 are not connected to patch panel 109, so icons 3415 and 3416 always represent editing systems 105 and 106, but again this information is not given in the interface. The important information given is the names of the framestores.

As shown by dotted lines 3421 and 3422, the user selects two framestores to swap by dragging a line connecting an editing system to a framestore so that it connects to a different framestore. When two such lines have been dragged, the user clicks on OK button 3423 and the two framestores to be swapped have been selected. In this example the user has selected framestores 111 and 114 to swap.

If the user selects either of framestores 115 or 116, which cannot be swapped because they are not connected to patch panel 109, the daemon detailed in FIG. 33 will still run but eventually an error message will be received from patch panel controlling system 108 to the effect that the swap cannot be achieved. This message is then displayed to the user and the user must select different framestores. It is envisaged that in such an environment as shown in FIG. 1 a user would be aware of which framestores are available to swap and which are not. However other embodiments are contemplated that use different ways of storing network connection data, and in such embodiments information such as this could be displayed to a user.

FIG. 35

FIG. 35 details 3306 at which the swap of the framestores is carried out. At step 3501 checks are carried out to ensure that the two processing systems involved in the swap are ready for the swap to take place. These checks include shutting down any applications that may be running, waiting for any wire transfers to be processed, checking that the framestore is not currently locked for some reason (for example one of the disks may be currently being changed or healed) and so on. Once the editing systems are ready to swap the Ethernet addresses of the two systems are sent to patch panel controlling system 108.

At step 3503 a message is received from the patch panel controlling system and at step 3504 a question is asked as to whether this message contains any errors. If this question is answered in the affirmative then an error message is displayed to the user of editing system 103 at step 3505. This immediately completes swap daemon 1309. However, if the question asked at step 3504 is answered in the negative, to the effect that the swap was carried out without errors, then at step 3506 messages are sent to the Ethernet addresses of the editing systems involved in the swap, as identified at step 3305. These messages indicate to each editing system involved in the swap the framestore ID of its new local framestore. In this example, ID 04 is sent to editing system 101, while ID 01 is sent to editing system 104. If editing system 103 were itself one of the editing systems involved in the swap, it would at this step effectively send a message to itself.

These messages are used by the editing systems involved in the swap and to update the versions of LOCALCONNECTIONS.CFG and NETWORKCONNECTIONS.CFG in their memories. They then broadcast on the network their new IDs and the other editing systems each update their versions of NETWORKCONNECTIONS.CFG. Thus the two configuration files are kept constantly up to date.

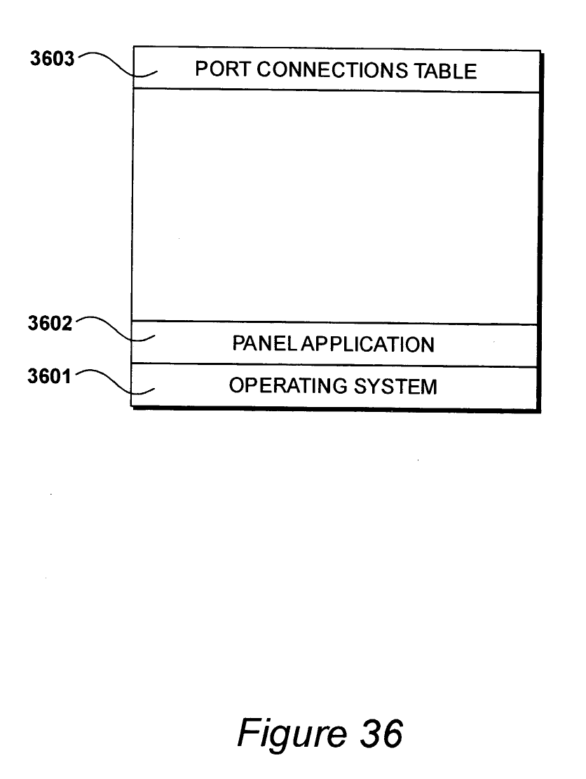

FIG. 36

FIG. 36 illustrates the contents of the memory of patch panel controlling system 108. Operating system 3601 includes message-sending and -receiving capabilities, and panel application 3602 controls patch panel 109. Among the data stored in the memory of patch panel controlling system 108 is port connections table 3603 which lists all the connections made within patch panel 109.

It will be apparent to the skilled user that patch panel 109 is only one solution to the problem of swapping connections between processing systems and storage means and that other switching means can be used without deviating from the scope of the invention. In this embodiment a patch panel is used because only one framestore is to be connected to each image editing system, and vice versa, at any one time and so a more costly solution is not necessary. However, there is no reason why another form of switching means, for example a fibre channel switch that routes and buffers packets between ports rather than forming a physical connection, should not be used. Additionally, the reason that only a single connection is allowed is to ensure that the bandwidth of that connection is not compromised. Other embodiments, however, are contemplated in which more bandwidth is available or is managed more efficiently, and in these embodiments switching means that allow multiple connections between processing systems and storage means could be used.

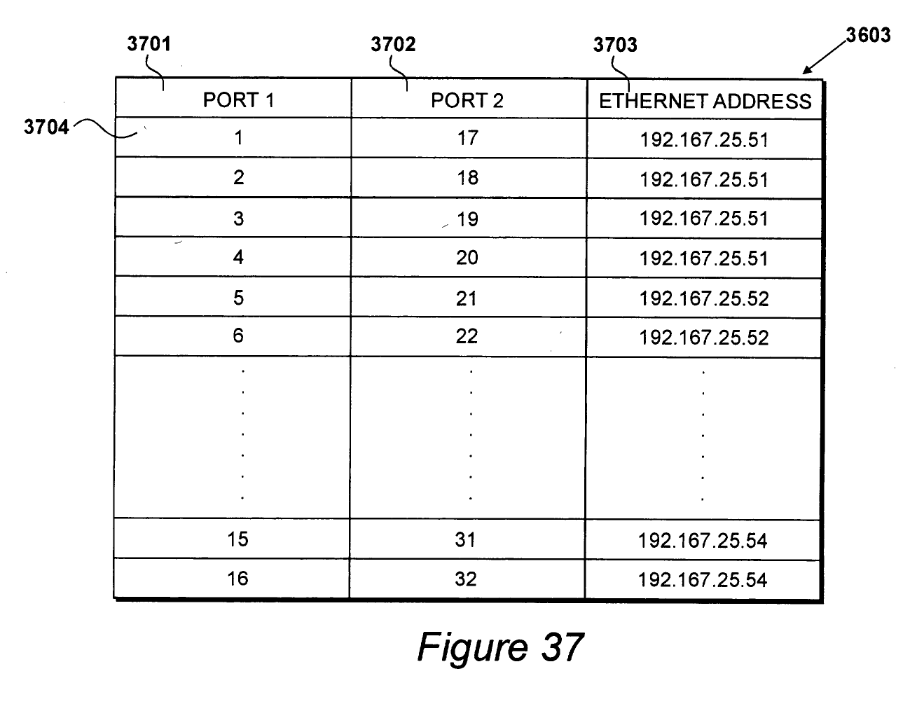

FIG. 37

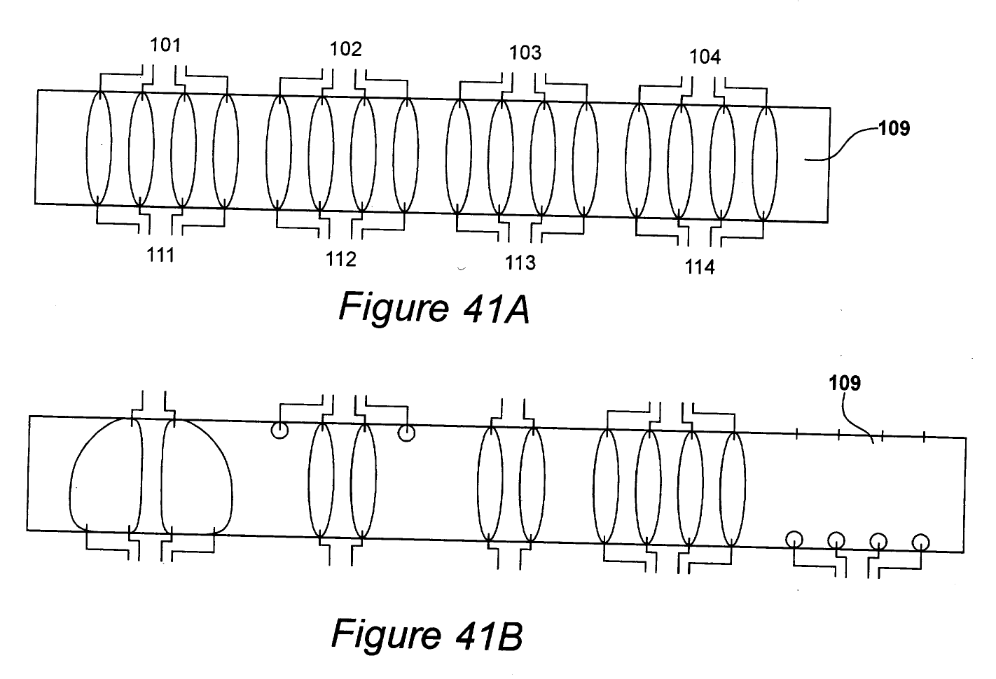

FIG. 37 illustrates port connections table 3603. Patch panel 109 includes thirty-two ports, sixteen of which are connected to editing systems 101 to 104, and sixteen of which are connected to framestores 111 to 114. In this example, each editing system and framestore uses four ports, although in other embodiments a greater number of framestores or editing systems could be used by allowing only two ports to some or all editing systems or framestores. In this case, two ports can be connected to four ports by creating loop backs or three-port zones, as will be further described with reference to FIG. 41.

Port connections table 3603 includes columns 3701, entitled PORT 1, and 3702, entitled PORT 2. Column 3703 then gives the Ethernet address of the editing system indicated by the number of the port in column 3401. For example, line 3704 shows that port 1 is connected to port 17, and that the Ethernet address of the editing system connected to port 1 is 192.167.25.01, which is the address of editing system 101. At this point, before the swap detailed in the previous Figures, editing system 101 controls framestore 111. Port 17 is a port connected to framestore 111. However, port connections table 3603 does not need this information.

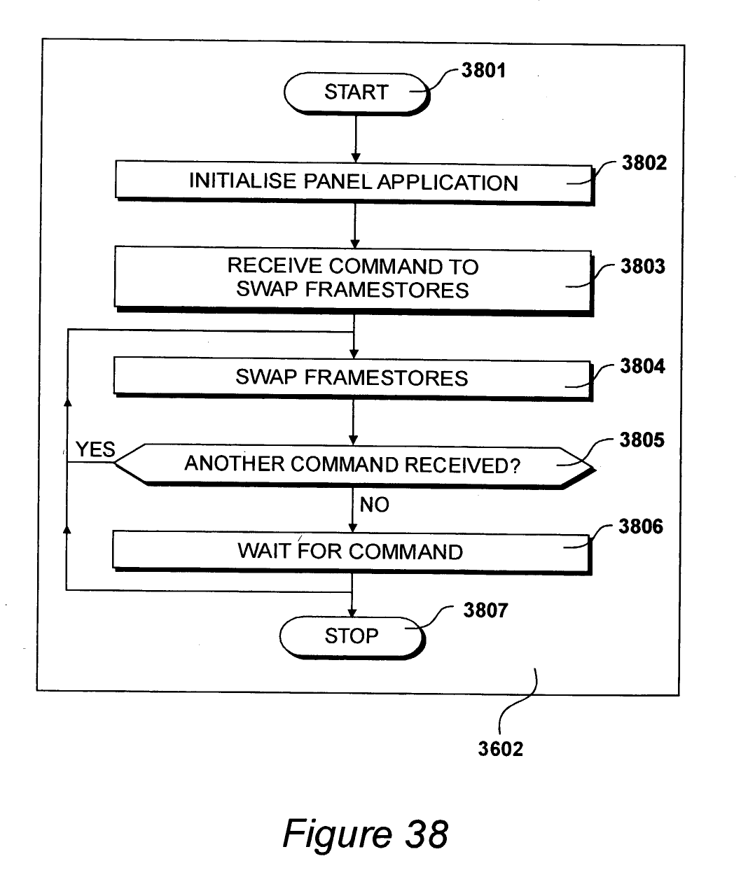

FIG. 38

FIG. 38 details panel application 3602. This application runs all the time that patch panel controlling system 108 is switched on, which in this embodiment is all the time except when maintenance is required. At step 3801 the application is started and at step 3802 it is initialised and then waits. At step 3803 a command is received to reprogram the patch panel, such as the command sent at step 3502 by swap daemon 1309 running on editing system 103, consisting of the Ethernet addresses of the swapping systems.

At step 3804 the patch panel is reprogrammed according to this command and at step 3805 a question is asked as to whether another command has been received. If this question is answered in the affirmative then control is returned to step 3804 and if answered in the negative it is directed to step 3806 at which the application waits for another command. When another command is received control is returned to step 3504. Alternatively, if patch panel controlling system 108 is powered down while the application is waiting for a command, the application stops at step 3807.

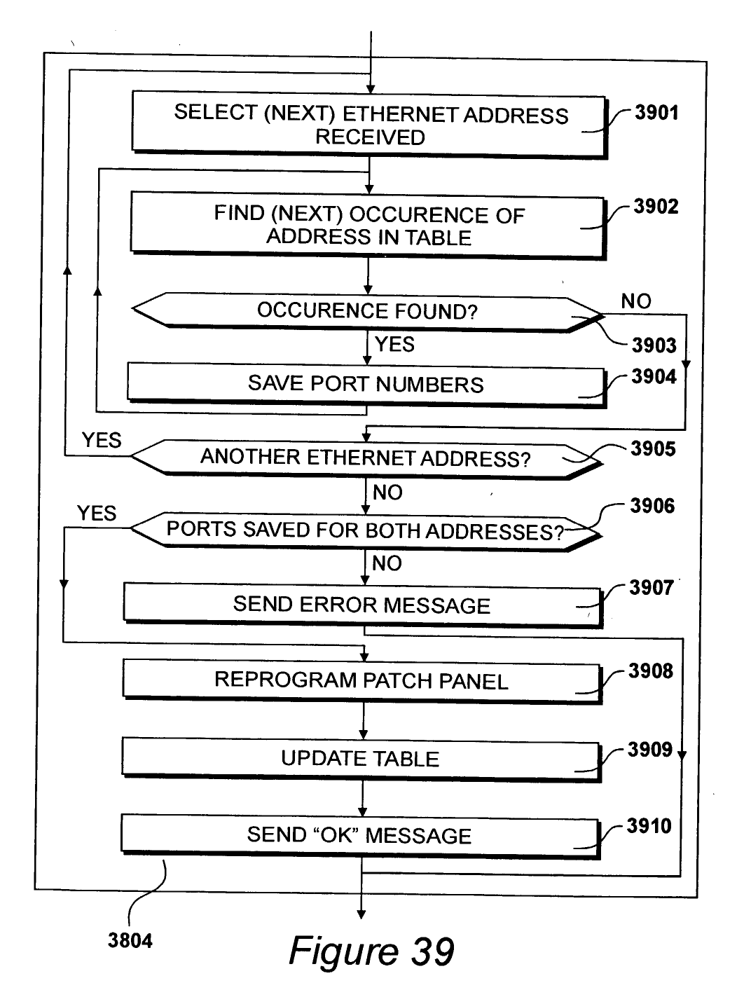

FIG. 39

FIG. 39 details step 3804 at which the patch panel is reprogrammed. At step 3901 the first Ethernet address received is selected and at step 3902 the first occurrence of that address in port connections table 3603 is searched for. At step 3903 a question is asked as to whether an occurrence has been found. If this question is answered in the affirmative then the two port numbers in the line where the address occurs are saved and control is returned to step 3902 to find the next occurrence. If the question asked at step 3903 is answered in the negative, then either the address does not occur in the table or all occurrences of that address have already been found.

Control is therefore directed to step 3905 at which a question is asked as to whether another Ethernet address is to be searched for. The first time this question is asked it will be answered in the affirmative. Control is returned to step 3901 and occurrences of the second address are searched for. When both addresses have been searched for the question asked at step 3905 will be answered in the negative and at step 3906 a question is asked as to whether port numbers have been saved for both Ethernet addresses. If this question is answered in the negative then at least one of the ports does not occur in the table and an error message is sent at step 3907 to the editing system which sent the command.

If the question asked at step 3906 is answered in the affirmative then at step 3908 the patch panel is reprogrammed by swapping the ports. Each port number that has been saved under the first Ethernet address and that is listed in column 3701 is disconnected from its current mate and reconnected to a port number that has been saved under the second Ethernet address and that is listed in column 3702. The reverse operation is also carried out.

At step 3909 table 3603 is updated and at step 3910 an “OK” message is sent to the editing system that sent the command.

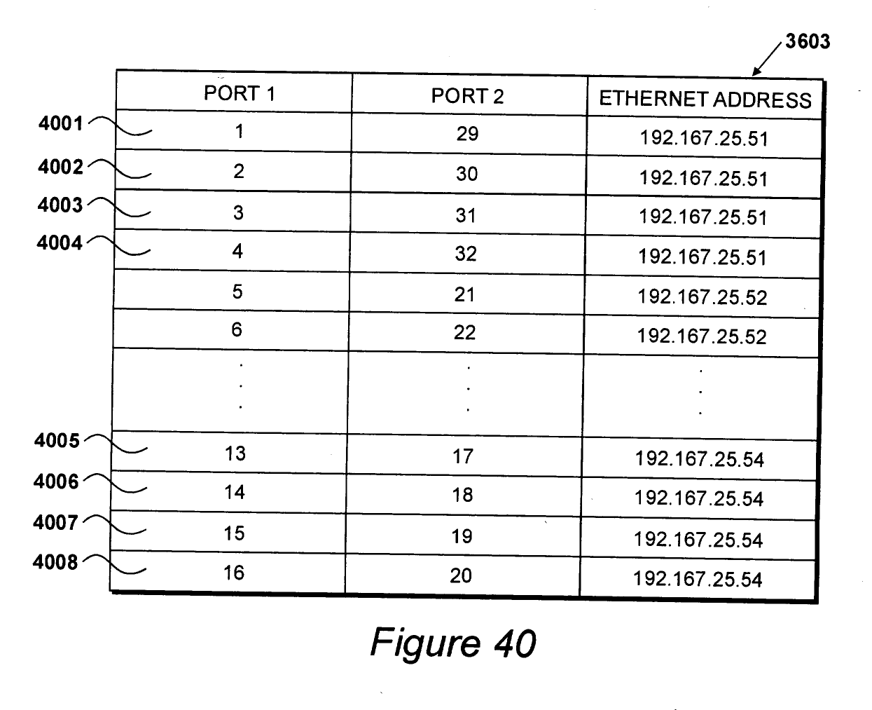

FIG. 40

FIG. 40 illustrates table 3603 after patch panel 109 has been reprogrammed. In this example, the framestore swap has been between editing systems 101 and 104. After the swap, editing system 101 controls framestore 114, which is shown at lines 4001 to 4004 by the fact that ports 1 to 4, shown in column 3703 to be connected to editing system 101, are now connected to port 29 to 32, which are connected to framestore 114. Similarly, lines 4005 to 4008 show that editing system 104 is connected to framestore 111.

FIGS. 41A and 41B

FIG. 41A illustrates the connections within patch panel 109 in the present embodiment. Each of the sixteen ports on each side is connected to another port, forming a two-port zone. Each of editing systems 101 to 104 and framestores 111 to 114 use four ports.

FIG. 41 however shows an example where four editing systems and five framestores are connected to the patch panel. The first editing system only uses two ports but the framestore to which it is connected uses four. Thus two three-port zones are formed, linking each single port connected to the editing system to two ports connected to the framestore.

The first editing system uses four ports whereas its local framestore only uses two. In this case two two-port zones are created between two of the ports of the editing system and the two ports of the framestore, while the remaining two ports of the editing system are looped back upon themselves to form two one-port zones.

The third editing system only uses two ports, as does the third framestore, and so they are connected by two two-port zones. The forth editing system and framestore both use four ports and so are connected by four two-port zones. The fifth framestore is currently not connected. Its ports are all looped back to form one-port zones and the framestore is said to be dangling. An editing system may not dangle but must always be connected to a framestore.

For an embodiment such as this port connection table 3603 would be slightly different and the reprogramming step at step 3804 would not be a simple swap of port numbers. However, the skilled user will appreciate that there are many ways of programming a patch panel such as this. In other embodiments (not shown) the patch panel could be replaced with a fibre channel switch or some other reprogrammable method of connecting the editing systems to the framestores.

1. Image editing apparatus, comprising:
a high bandwidth switching means,
a plurality of image processing systems, at least one of which is connected to said high bandwidth switching means,
an additional processing system connected to said plurality of processing systems, and
a plurality of frame storage means, at least one of which is connected to said high bandwidth switching means; wherein
said high bandwidth switching means is configured to make a connection between a first image processing system and a first frame storage means, wherein said first image processing system and said first frame storage system are both connected to said high bandwidth switching means, and
said first image processing system reads data stored on said additional processing system that is necessary to access frames stored on said first frame storage means.

2. Apparatus as claimed in claim 1, wherein said frames are stored on said frame storage means as clips of frames and said data necessary to access said frames comprises information specifying, for each frame, the clip to which it belongs and its position in said clip.

3. Apparatus as claimed in claim 2, wherein said data necessary to access said frames additionally comprises information specifying effects to be applied to each frame.

4. Apparatus as claimed in claim 3, wherein said data necessary to access said frames additionally comprises information specifying, for each frame, the location of image data on said frame storage means that constitutes each said frame.

5. Apparatus as claimed in claim 3, wherein for each frame storage means information is stored on said frame storage means that specifies, for each frame, the location of image data on said frame storage means that constitutes each said frame.

6. Apparatus according to claim 3, wherein each of said frame storage means includes a plurality of disks configured to receive frame stripes.

7. Apparatus according to claim 6, wherein said disks are configured as at least one redundant array of inexpensive disks (RAID).

8. Apparatus as claimed in claim 7, wherein said additional processing system is connected to said plurality of image processing systems by a low bandwidth connection.

9. Apparatus as claimed in claim 8, wherein said high bandwidth switching means is an electronic fibre optic patch panel.

10. Image editing apparatus, comprising:
a high bandwidth switching means,
a plurality of image processing systems, at least one of which is connected to said high bandwidth switching means,
an additional processing system connected to said plurality of processing systems, and
a plurality of frame storage means, at least one of which is connected to said high bandwidth switching means, wherein each of said frame storage means includes a plurality of disks configured to receive frame stripes; wherein
said high bandwidth switching means is configured to make a connection between a first image processing system and a first frame storage means, wherein said first image processing system and said first frame storage system are both connected to said high bandwidth switching means, and
said first processing system reads data stored on said additional processing system that is necessary to access frames stored on said first frame storage means, wherein said data comprises information specifying, for each frame, the clip to which it belongs, its position in said clip and effects to be applied to said frame.

11. In an image processing environment comprising
a high bandwidth switching means,
a plurality of image processing systems, at least one of which is connected to said high bandwidth switching means,
an additional processing system connected to said plurality of processing systems, and
a plurality of frame storage means, at least one of which is connected to said high bandwidth switching means;
a method of processing image data comprising the steps of:
connecting, via said high bandwidth switching means, a first image processing system to a first frame storage means, wherein said first image processing system and said first frame storage means are both connected to said high bandwidth switching means;
reading, at said first image processing system, data stored on said additional processing system; and
using, at said first image processing system, said data to access frames stored on said first frame storage means.

12. A method as claimed in claim 11, wherein said frames are stored on said frame storage means as clips of frames and said data necessary to access said frames comprises information specifying, for each frame, the clip to which it belongs and its position in said clip.

13. A method as claimed in claim 12, wherein said data necessary to access said frames additionally comprises information specifying effects to be applied to each frame.

14. A method as claimed in claim 13, wherein said data used to access said frames additionally comprises information specifying, for each frame, the location of image data on said frame storage means that constitutes each said frame.

15. A method as claimed in claim 13, wherein for each frame storage means information specifying the location of image data that constitutes each of said frames on said frame storage means is stored on said frame storage means.

16. A method according to claim 13, wherein each of said frame storage means includes a plurality of disks configured to receive frame stripes.

17. A method according to claim 16, wherein said disks are configured as at least one redundant array of inexpensive disks (RAID).

18. Apparatus as claimed in claim 17, wherein said additional processing system is connected to said plurality of image processing systems by a low bandwidth connection.

19. A method as claimed in claim 18, wherein said high bandwidth switching means is an electronic fibre optic patch panel.

20. In an image processing environment comprising
a high bandwidth switching means,
a plurality of image processing systems, at least one of which is connected to said high bandwidth switching means,
an additional processing system connected to said plurality of processing systems, and
a plurality of frame storage means, at least one of which is connected to said high bandwidth switching means, wherein each of said frame storage means includes a plurality of disks configured to receive frame stripes;
a method of processing image data comprising the steps of:
connecting, via said high bandwidth switching means, a first image processing system to a first frame storage means, wherein said first image processing system and said first frame storage means are both connected to said high bandwidth switching means;
reading, at said first image processing system, data stored on said additional processing system, wherein said data comprises information specifying, for each frame on said first frame storage means, the clip to which it belongs, its position in said clip and effects to be applied to said frame; and
using, at said first image processing system, said data to access frames stored on said first frame storage means.
